(19) United States
(12) Patent Application Publication
(10) Pub. No.: US 2026/0219095 A1
(43) Pub. Date: Jul. 30, 2026

(54) ACCELEROMETER LOCATIONS IN A VEHICLE FOR WEIGHT ESTIMATION AND ASSOCIATED METHODS

(71) Applicant: Ford Global Technologies, LLC, Dearborn, MI (US)

(72) Inventors: Shane Edward Foley, Milford, MI (US); Andrew Robert Wolf, Northville, MI (US); Christopher John-Ruwan Desilva, Canton, MI (US); Elliott George Pearson, Shelby Township, MI (US)

(21) Appl. No.: 19/040,759

(22) Filed: Jan. 29, 2025

(51) Int. Cl. G01G 19/02; G01G 19/08; G01G 19/12; G01G 21/28

(52) U.S. Cl. CPC G01G 19/021; G01G 19/086; G01G 19/12; G01G 21/28

(57) ABSTRACT

Accelerometer locations in a vehicle for weight estimation and associated methods are disclosed. An example vehicle includes a suspension system including an upper control arm, a lower strut joint, or a leaf spring and a shackle to operatively couple a wheel to a frame of the vehicle, and an accelerometer coupled to the upper control arm, the lower strut joint, or the shackle, a position of the accelerometer to change when the upper control arm, the lower strut joint, or the shackle moves from a change in a load being supported by the vehicle.

### FIELD OF THE DISCLOSURE

This disclosure relates generally to vehicles and, more particularly, to accelerometer locations in a vehicle for weight estimation and associated methods.

### BACKGROUND

Some vehicles (e.g., vans, trucks, sports utility vehicles (SUVs), etc.) can carry significant loads and often have weight limits that should not be exceeded. As such, to ensure proper vehicle handling and/or performance during normal use, a vehicle should not be loaded (e.g., with people, cargo, freight, etc.) greater than a weight limit of the vehicle. A user of the vehicle can visually inspect the vehicle to determine if a vehicle is overloaded. Alternatively, a vehicle can be driven to a weigh station to determine of a weight and/or load of the vehicle.

### SUMMARY

An example vehicle disclosed herein includes a suspension system including an upper control arm, a lower strut joint, or a leaf spring and a shackle to operatively couple a wheel to a frame of the vehicle, and an accelerometer coupled to the upper control arm, the lower strut joint, or the shackle, a position of the accelerometer to change when the upper control arm, the lower strut joint, or the shackle moves from a change in a load being supported by the vehicle.

An example vehicle disclosed herein includes a suspension system including an upper control arm or a leaf spring and a shackle to couple an end of the leaf spring to a frame of the vehicle, the leaf spring including leaves and a clinch clip to couple the leaves, and an accelerometer to couple to the upper control arm, the shackle, or the clinch clip.

An example vehicle disclosed herein includes a suspension system including at least one of an upper control arm, a lower control arm, a leaf spring, or a shackle to couple an end of the leaf spring to a frame of the vehicle, and an accelerometer including a first end and a second end opposite the first end, the first end coupled to the upper control arm, the lower control arm, the shackle, or the leaf spring, the accelerometer disposed at an angle that positions at least a portion of the second end above the first end.

### BRIEF DESCRIPTION OF THE DRAWINGS

FIG. 1 illustrates an example accelerometer location in a vehicle.

FIG. 2A is an isolated view of the example accelerometer.

FIG. 2B is a schematic representation of a drainage path associated with a portion of the accelerometer of FIGS. 1-2.

FIGS. 3-11B illustrate example accelerometer locations in a vehicle.

FIGS. 12A-12C illustrate an example vehicle having example accelerometers in the example front and/or rear positions of FIGS. 1, 3, 4, 5, 6, 7, 8, 9A-9B, 10, and/or 11A-11B and example accelerometer position analysis circuitry to assess a position of the respective scale sensors in accordance with teachings of this disclosure.

FIG. 13 is a block diagram of the example sensor position analysis circuitry of FIG. 12A.

FIG. 14 is a flowchart representative of example machine readable instructions and/or example operations that may be executed, instantiated, and/or performed by example programmable circuitry to implement the sensor position analysis circuitry of FIGS. 12A and 13.

FIG. 15 is a block diagram of an example processing platform including programmable circuitry structured to execute, instantiate, and/or perform the example machine readable instructions and/or perform the example operations of FIG. 14 to implement the sensor position analysis circuitry of FIGS. 12A-13.

In general, the same reference numbers will be used throughout the drawing(s) and accompanying written description to refer to the same or like parts. The figures are not necessarily to scale.

### DETAILED DESCRIPTION

As used herein, the orientation of features is described with reference to a lateral axis, a vertical axis, and a longitudinal axis of the vehicle associated with the features. As used herein, the longitudinal axis of the vehicle is parallel to a centerline of the vehicle. The terms “rear” and “front” are used to refer to directions along the longitudinal axis closer to the rear of the vehicle and the front of the vehicle, respectively. As used herein, a surface that faces a “frontward direction” refers to a surface where a vector extending normal to the surface extends toward the front of the vehicle. As used herein, a surface that faces a “rearward direction” refers to a surface where a vector extending normal to the surface extends toward the rear of the vehicle.

As used herein, the vertical axis of the vehicle is perpendicular to the surface or ground on which the vehicle rests. The terms “below” and “above” are used to refer to directions along the vertical axis closer to the ground and away from the ground, respectively.

As used herein, the lateral axis of the vehicle is perpendicular to the longitudinal and vertical axes and is generally parallel to the axles of the vehicle. As used herein, a surface that faces a “lateral direction” refers to a surface where a vector extending normal to the surface is substantially parallel to the lateral axis of the vehicle. As used herein, the term “substantially parallel” encompasses the term parallel and more broadly encompasses a meaning whereby a first object (e.g., a first axis, a first vector, etc.) is positioned and/or oriented relative to a second object (e.g., a second axis, a second vector, etc.) at an absolute angle of no more than ten degrees (10°) from parallel. For example, a vector that is substantially parallel to an axis is positioned and/or oriented relative to the axis at an absolute angle of no more than ten degrees (10°) from parallel.

As used herein, the “gross axle weight” of a vehicle refers to a gross weight of a vehicle unless indicated otherwise. As used herein, a “curb weight” of a vehicle refers to a weight of the vehicle including fuel but not including passengers or cargo. As used herein, the “load,” the “mass,” and/or the “weight” on a vehicle refers to the difference between the gross weight of the vehicle and the curb weight of a vehicle (e.g., the weight of the vehicle hardware and consumables, etc.). The load on a vehicle typically includes the weight added by a user of a vehicle (e.g., the weight of the passengers of the vehicle, cargo loaded in the vehicle, etc.). As used herein, the “load condition” of a vehicle refers to the load on a vehicle as well as the distribution of the load on the vehicle. As used herein, “misloading a vehicle” and all variations thereof, refers to a load condition that adversely affects the performance of the vehicle, and can, for example, include exceeding the gross axle weight rating (GAWR) of one or both axles, exceeding a weight rating of a suspension system, unbalancing a weight distribution associated with the vehicle, etc.

As used herein, a “rebound position” is a lowest point of travel associated with a suspension system of a vehicle. Specifically, the “rebound position” can be obtained in two different scenarios. First, in a static rebound scenario, the vehicle is on a lift and a weight of the suspension system causes the suspension system to move downward (e.g., droop) away from a body of the vehicle such that the suspension system is at the lowest point of travel. That is, the suspension is configured to be in a position that results in an increased (e.g., a maximum) separation from the body in the vertical direction. Second, in a dynamic rebound scenario, driving conditions associated the surface or ground on which the vehicle is moving results in an input from the suspension system that causes unsprung components to accelerate downward to the lowest point of travel.

As used herein, a “rated position” corresponds to a predetermined position of a suspension component that is associated with a particular weight. The rated position can be anywhere between a jounce position and a rebound position associated with the suspension component. The jounce position and the rebound position define a maximum range of travel associated with a suspension component. As such, the range between the jounce position and the rebound position also encompasses a curb position and a GAWR position. Typically, the rated position is between the curb position and the GAWR position. The rated position is often a position at which the suspension system is designed (e.g., in a computer aided design (CAD) program) during product development.

Drivers often desire to know vehicle weight and/or vehicle weight distribution of a vehicle to improve loading practices, comply with regulatory weight limits, and/or facilitate vehicle handling. Some vehicles include vehicle weight measurement systems to measure vehicle weight when the vehicle is in motion and/or stationary. Some known vehicle weight measurement systems calculate suspension position at one or more wheels of a vehicle by generating a vehicle-specific transfer function to relate inputs (e.g., sensor measurements) to outputs (e.g., suspension position). Such vehicle weight measurement systems can generate a characteristic curve for respective one(s) of the wheels based on the vehicle-specific transfer function, and the characteristic curves can be used to estimate additional vehicle properties such as vehicle weight, wheel-end force, mass, etc. However, some vehicle weight measurement systems can have error factors, which can decrease the accuracy of the resulting vehicle weight measurements.

Accelerometer location for weight estimation for vehicles and associated methods are disclosed. Examples disclosed herein provide example accelerometer locations (e.g., position, placement, orientation, etc.) in a vehicle suspension system that enable the accelerometer to change angular orientation at a magnitude proportional to a weight loaded on the vehicle. Example accelerometer positions disclosed herein facilitate an estimation and/or determination of a weight (e.g., a vehicle weight, an axle weight, etc.) associated with the vehicle such that the weight can be presented and/or displayed to facilitate loading and/or operation of the vehicle. Examples disclosed herein analyze a given accelerometer location and/or type of accelerometer to determine an optimal location and/or type of accelerometer for a particular vehicle model and/or suspension system. In examples disclosed herein, an orientation of the accelerometer pivots by no more than approximately one degree (1°) per 50 kilograms (kg) added to the vehicle between a curb weight and a gross axle weight rating of the vehicle to ensure that weight estimation techniques that utilize the accelerometer provide accurate data.

Further, the accelerometers are positioned on (e.g., directly coupled to) a metal surface to facilitate vehicle prognostics. In some examples, the accelerometer locations also enable easy access for serviceability (e.g., for inspection and/or relocation). In some examples, the position(s) of the accelerometer(s) provides protection during off-roading and/or are distanced from areas of the vehicle that typically encounter snow buildup. In some examples, the accelerometer(s) are angled upwards to prevent water (e.g., rainwater) from contacting electrical components thereof.

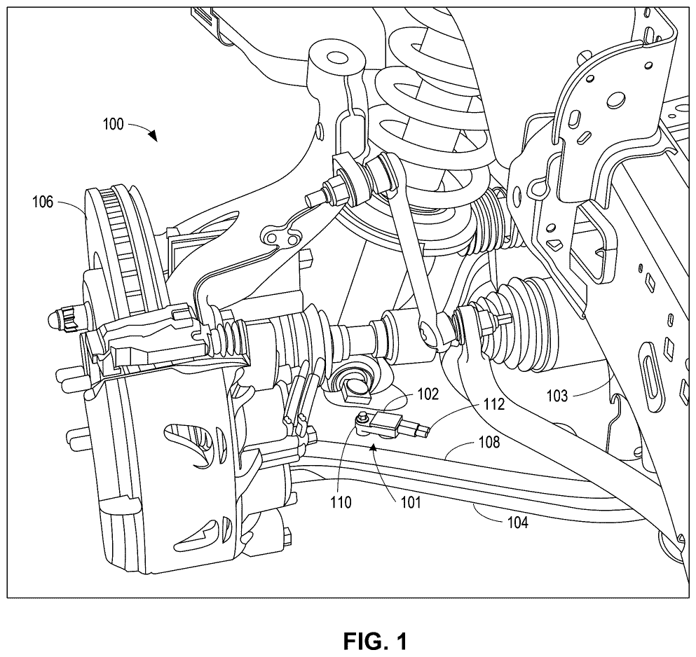

Referring now to the drawings, FIG. 1 illustrates a suspension system 100 of a vehicle including a first example location 101 of an accelerometer 102. The suspension system 100 is an independent front suspension system that couples a frame 103 to a wheel of the vehicle. The suspension system 100 can be mirrored by another independent front suspension system (e.g., a second implementation of the suspension system 100) on an opposite side of the vehicle (e.g., a right side of the vehicle when the suspension system 100 is on a left side). The independent suspension system 100 enables a wheel coupled thereto to move generally vertically independent of other wheels of the vehicle.

The suspension system 100 includes a lower control arm 104 that couples a lower portion of a wheel hub assembly 106 to the frame 103 of the vehicle. Additionally, the lower control arm 104 is coupled (e.g., rotatably and/or pivotably coupled) to the frame 103 of the vehicle. The lower control arm 104 is rotatable and/or pivotable about a rotational axis defined between two fasteners (e.g., two bushings) at which the lower control arm 104 couples to the frame 103.

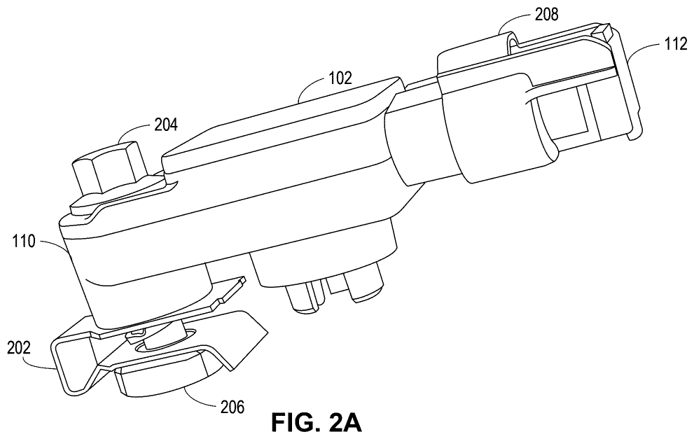

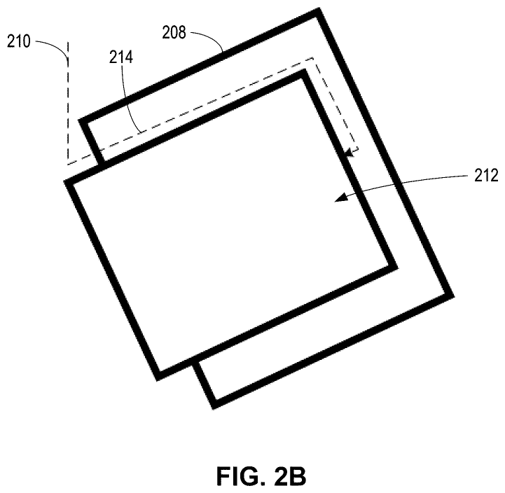

In the illustrated example of FIG. 1, the accelerometer 102 is positioned on and/or coupled to the lower control arm 104. As such, the accelerometer 102 can pivot and/or rotate with the control arm about the rotational axis. In this example, the accelerometer 102 is coupled to and/or positioned on/above an upward-facing surface 108 of the lower control arm 104. Specifically, a J-clip, nut, and bolt assembly couple directly to a first end 110 of the accelerometer 102 and to the lower control arm 104. The J-clip nut and bolt are shown in greater detail in FIG. 2A.

The accelerometer 102 is a tri-axis accelerometer that measures acceleration (e.g., an x-acceleration, a y-acceleration, a z-acceleration) along three dimensions and/or axes (e.g., an x-axis, a y-axis, a z-axis). The location of the accelerometer 102 causes the accelerometer 102 to have an angular orientation that is directly related to a weight supported by the vehicle. For example, the accelerometer 102 encounters a change in angular orientation proportional to a weight added onto or removed from a load supported by the frame 103 of the vehicle. Specifically, the lower control arm 104 can move (e.g., pivot, rotate, translate) relative to the frame 103 of the vehicle when the load supported by the vehicle changes. As a result, the accelerometer 102 moves relative to the frame 103 of the vehicle (e.g., an angular orientation of the accelerometer 102 changes) in a manner that corresponds to a magnitude of a change in the load supported by the vehicle (e.g., supported by a front axis of the vehicle). The data associated with the position and/or movement of the accelerometer 102 can be processed to determine the magnitude of the load on the vehicle.

In the illustrated example of FIG. 1, the accelerometer 102 is disposed at an angle that positions at least a portion of a second end 112 of the accelerometer 102 (e.g., opposite the first end 110) above the first end 110. As such, the location of the accelerometer 102 prevents water from contacting electrical components, as discussed further in association with FIGS. 2A-2B. Further, the accelerometer 102 is oriented to maintain the second end 112 above the first end 110 when a load of the vehicle is equivalent to or between the curb weight and the gross axle weight rating such that at least a portion of the second end 112 remains above the first end 110 during operation of the vehicle.

In the illustrated example of FIG. 1, the location 101 of the accelerometer 102 protects the accelerometer 102 from off-road obstacles and/or debris (e.g., rocks, sticks/branches, berms, etc.). Specifically, the location 101 of the accelerometer 102 is aft of a wheel center to protect the accelerometer 102 from contacting debris and/or obstacles encountered forward of the wheel and to enable the wheel to move the accelerometer 102 out of the way of such debris and/or obstacles. Further, the location 101 of the accelerometer 102 is forward of a furthest rear portion of a tire in contact with a ground surface to avoid obstacles and/or debris that the tire may kick up.

FIG. 2A is an isolated view of the example accelerometer 102 of FIG. 1 coupled to a J-clip 202, nut 204, and bolt 206. In the illustrated example of FIG. 2A, the accelerometer 102 includes the first end 110 and the second end 112, which is located at an opposite longitudinal end of the accelerometer 102 from the first end 110. In the illustrated example of FIG. 2A, the J-clip 202, nut 204, and bolt 206 couple the accelerometer 102 to the lower control arm 104 (FIG. 1). The accelerometer 102 includes a cap 208 positioned on the second end 112 to block access to internal electronic components (e.g., sensing elements and associated circuitry) positioned between the first end 110 and the second end 112. The accelerometer 102 is oriented to position at least a portion of the second end 112 above the first end 110 to cause gravity to direct any liquid, such as water (e.g., rainwater), that contacts the accelerometer 102 away from the second end 112 and, thus, away from the internal electronic components.

FIG. 2B is a schematic cross-section of the second end 112 of the accelerometer 102 that depicts a path 210 that a liquid would follow to infiltrate the cap 208 and contact internal electronic components 212. As shown, the path 210 requires the liquid to move in a direction 214 at least partially against gravity to enter the cap 208. As such, orienting the second end 112 above the first end 110 drains the liquid away from the second end 112 (e.g., towards the first end 110) as a result of the force of gravity thereby blocking liquid from flowing into the cap 208 and contacting the internal electronic components 212 associated with the accelerometer 102.

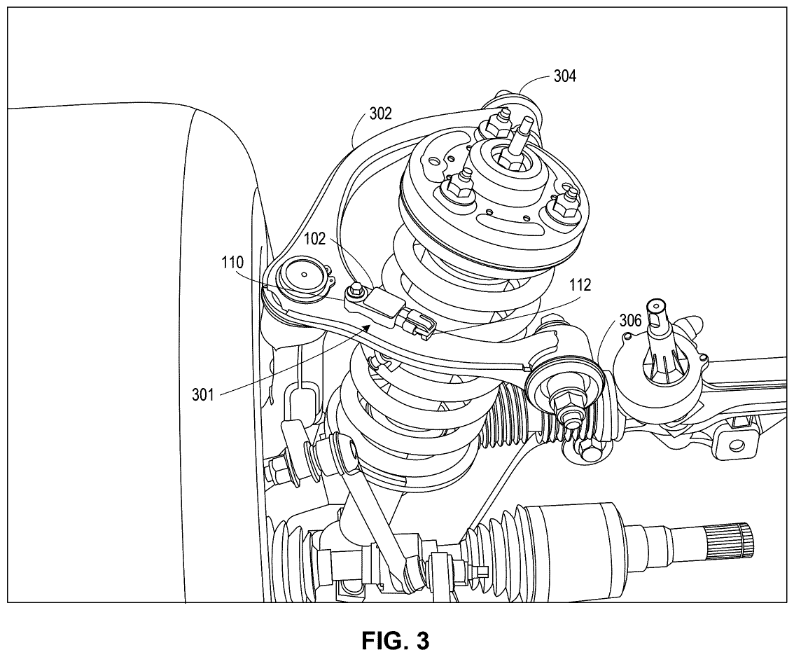

FIG. 3 illustrates another example location 301 of the accelerometer 102 in the suspension system 100 of FIG. 1. In the illustrated example of FIG. 3, the accelerometer 102 is coupled to an upper control arm 302 of the suspension system 100. In the illustrated example of FIG. 3, the accelerometer 102 is disposed at an angle that positions at least a portion of the second end 112 of the accelerometer 102 above the first end 110. The upper control arm 302 couples to the frame of the vehicle at a first example fastener 304 and a second example fastener 306. As such, the upper control arm 302 is rotatable and/or pivotable relative to the frame of the vehicle about an example rotational axis that extends from the first fastener 304 to the second fastener 306. As a result, the accelerometer 102 pivots and/or rotates with the upper control arm 302 about the axis between the fasteners 304, 306 when a load supported by the vehicle changes.

Similar to the location 101 of FIG. 1, the location 301 of the accelerometer 102 protects the accelerometer 102 from off-road obstacles and/or debris (e.g., rocks, sticks/branches, berms, etc.). That is, the location 301 of the accelerometer 102 is aft of a wheel center to protect the accelerometer 102 from contacting debris and/or obstacles encountered forward of the wheel and to enable the wheel to move the accelerometer 102 out of the way of such debris and/or obstacles. Further, the location 301 has an increased elevation (e.g., separation from the driving surface) to prevent the accelerometer 102 from encountering debris that ricochets off a wheel-liner.

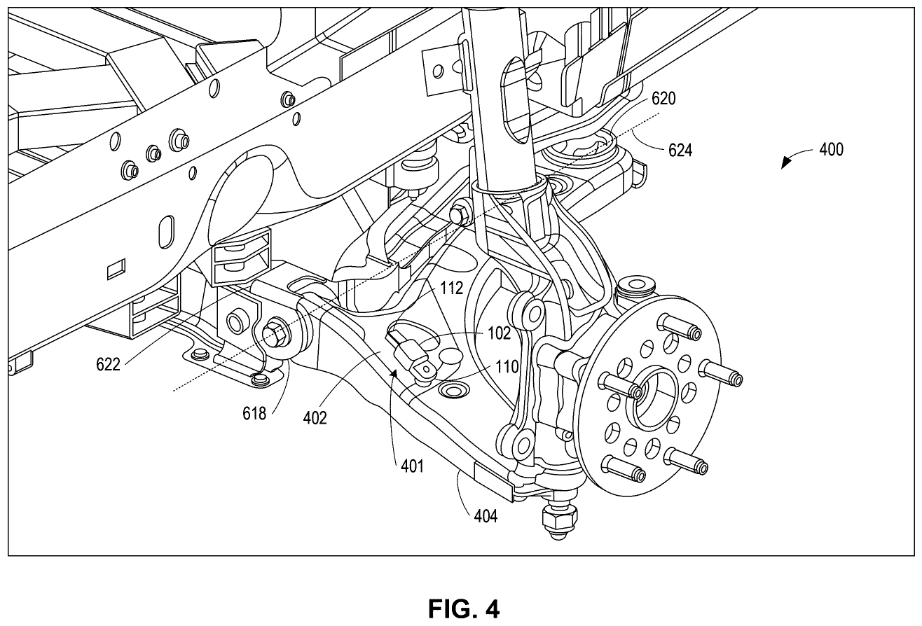

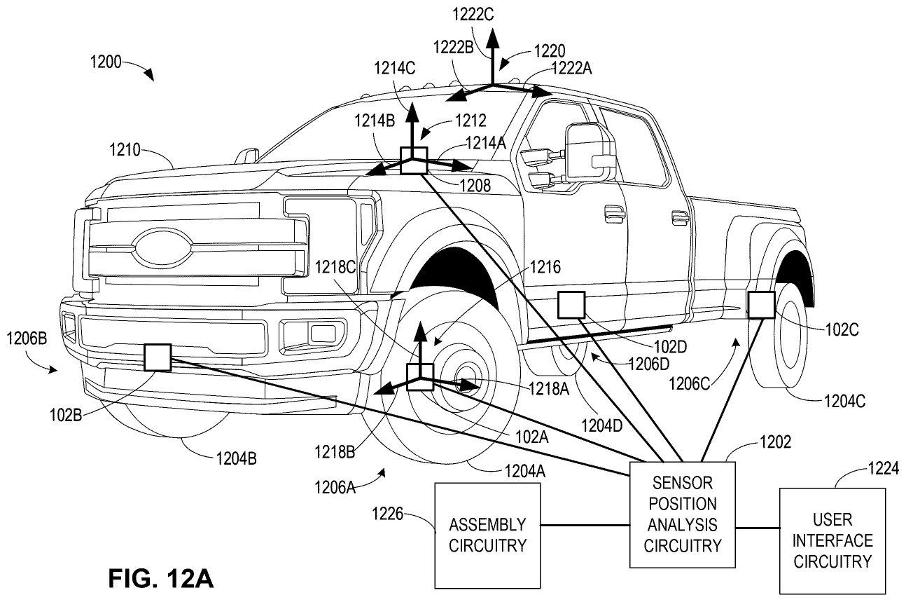

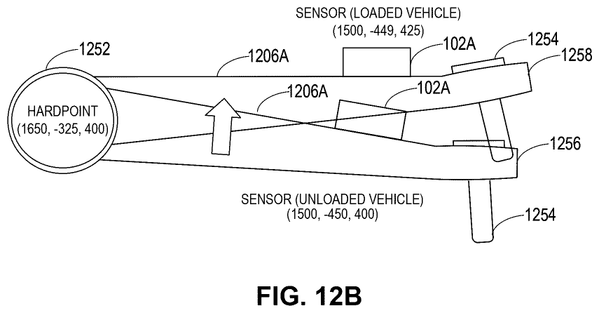

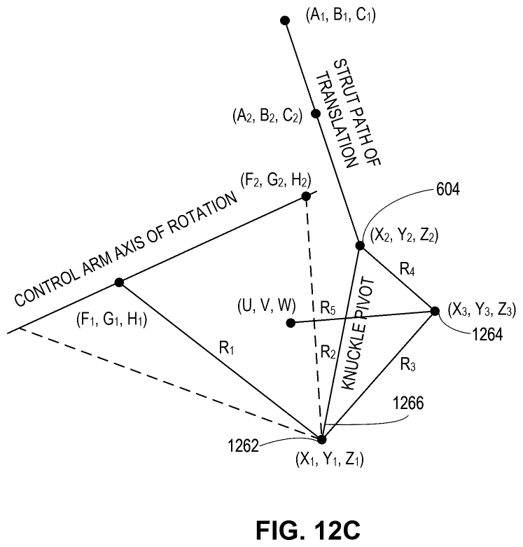

FIGS. 4, 5, and 6 illustrate another example suspension system 400 for a vehicle with different example locations of the accelerometer 102. The different example locations of the accelerometer 102 can be analyzed to determine the location that provides a preferable load estimation accuracy and, thus, a preferable location for the accelerometer 102 in the suspension system 400 and/or in a vehicle that includes the suspension system 400, as discussed in further detail below in connection with FIGS. 12-14.

FIG. 4 illustrates an example location 401 of the accelerometer 102 on an upward-facing surface 402 of a lower control arm 404 of the suspension system 400. In the illustrated example of FIG. 4, the accelerometer 102 is disposed at an angle that positions at least a portion of the second end 112 of the accelerometer 102 above the first end 110.

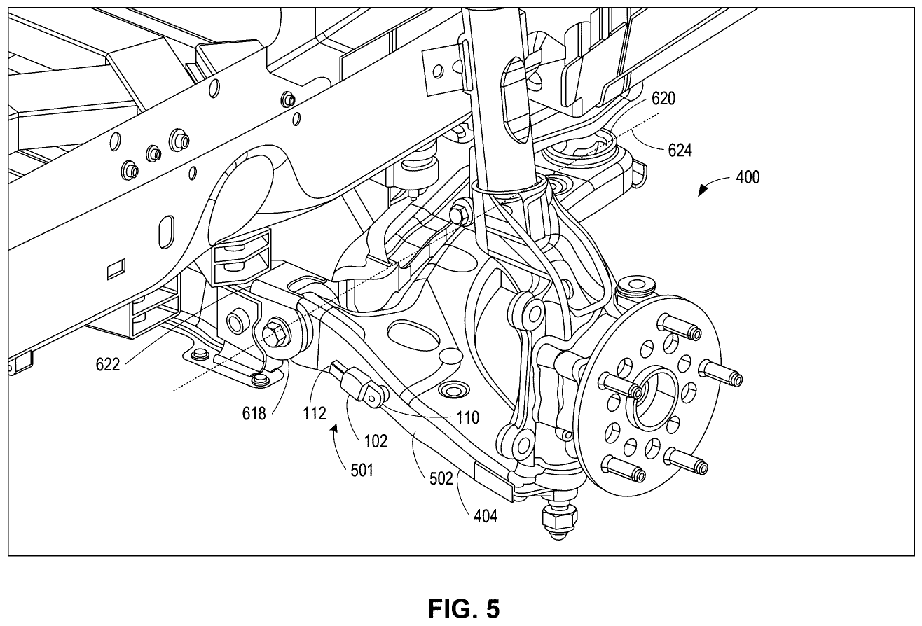

FIG. 5 illustrates another example location 501 of the accelerometer 102 on a surface 502 of the lower control arm 404 that faces a longitudinal direction defined by the vehicle. For example, the surface 502 can face a front of the vehicle or a rear of the vehicle (e.g., a frontward-facing surface, a rearward-facing surface). In the illustrated example of FIG. 5, the accelerometer 102 is disposed at an angle that positions at least a portion of the second end 112 of the accelerometer 102 above the first end 110.

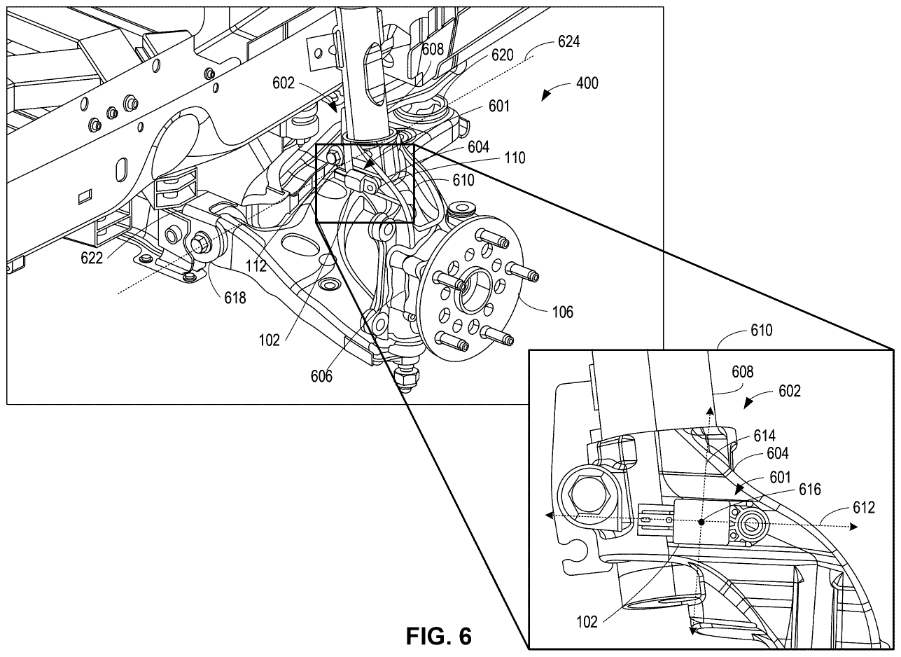

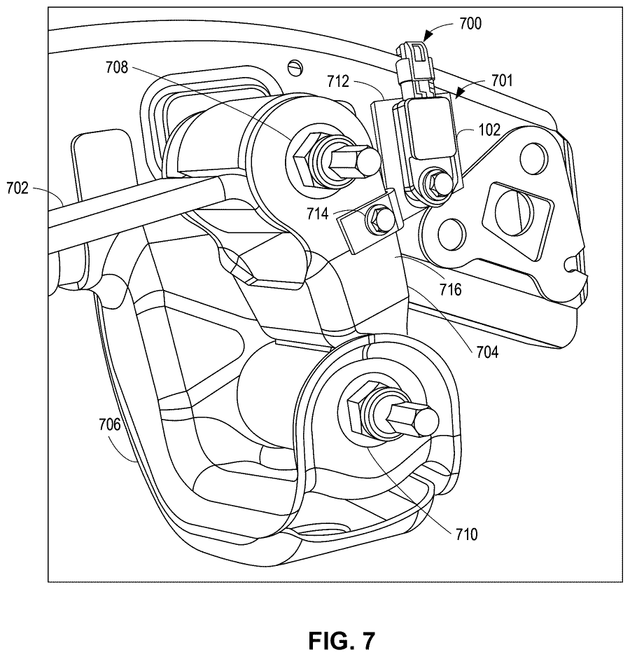

FIG. 6 illustrates another example location 601 of the accelerometer 102 on a strut assembly 602 of the suspension system 400. Specifically, in the illustrated example of FIG. 6, the accelerometer 102 is coupled to a lower strut joint 604 (e.g., a lower end of the strut assembly 602, a knuckle-strut joint). As such, the accelerometer 102 of FIG. 6 is positioned above a knuckle 606 and/or the wheel hub assembly 106. Further, the accelerometer 102 of FIG. 6 is positioned below a portion of a strut tube 608 associated with the strut assembly 602. The strut assembly 602 also includes an upper mount (not shown) coupled to the strut tube 608 at an upper end thereof. In the illustrated example of FIG. 6, the accelerometer 102 is disposed at an angle that positions at least a portion of the second end 112 of the accelerometer 102 above the first end 110. As shown in a magnified view 610 of the accelerometer 102 of FIG. 6, the accelerometer 102 of FIG. 6 is oriented to measure acceleration along an x-axis 612, a y-axis 614, and a z-axis 616 (e.g., an axis perpendicular to the page relative to the magnified view 610).

In the illustrated example of FIGS. 4, 5, and 6, the suspension system 400 includes a first fastener 618 (e.g., a first bushing) and a second fastener 620 (e.g., a second bushing) that couple the lower control arm 404 to a frame 622 of the vehicle. The lower control arm 404 and/or the strut assembly 602 pivot and/or rotate about a rotational axis 624 that extends between the first fastener 618 and the second fastener 620 in response to the frame 622 encountering a load change. As such, the accelerometers 102 of FIGS. 4-6 move (e.g., translate, pivot, rotate) with the lower control arm 404 and/or the strut assembly 602. As such, the position and/or movement of the accelerometers 102 of FIGS. 4-6 is directly related to a magnitude of the load supported by the frame 622. Thus, the position and/or movement of the accelerometer(s) 102 of FIGS. 4-6 can be processed to determine the magnitude of the load on the vehicle. In the illustrated example of FIGS. 4, 5, and 6, the suspension system 400 is not optimized for off-road usage. In these examples, the locations 401, 501, 601 are optimized for serviceability (e.g., repair, replacement), weight estimation accuracy, and/or weight estimation precision (e.g., degree of rotation per weight change).

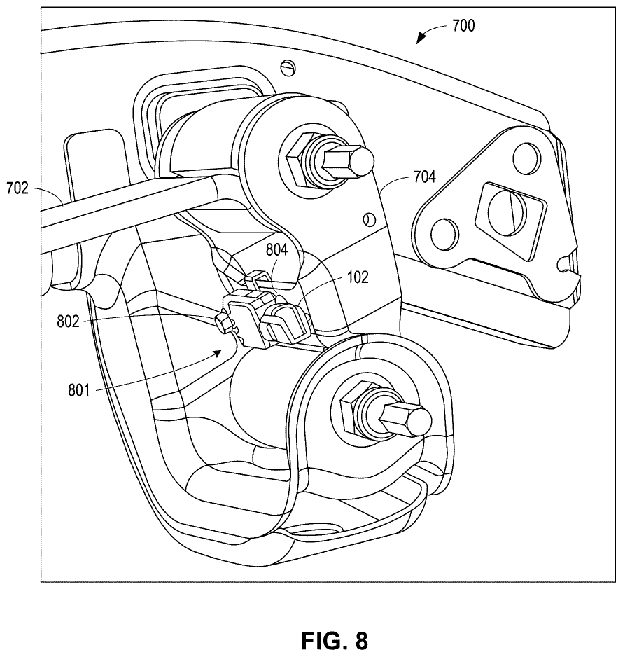

FIG. 7 illustrates another example suspension system 700 of a vehicle including another example location 701 for the accelerometer 102 to facilitate a vehicle load determination. The suspension system 700 of FIG. 7 is a rear suspension system that is operatively coupled to a wheel of the vehicle. Specifically, the suspension system 700 is a Hotchkiss rear suspension system. The suspension system 700 can be utilized in a same vehicle as the suspension system 100 of FIGS. 1 and 3 and/or in a same vehicle as the suspension system 400 of FIGS. 4, 5, and 6.

In the illustrated example of FIG. 7, the suspension system 700 includes a leaf spring 702 coupled to a shackle 704, which couples to a frame 706 of the vehicle. Specifically, a first fastener 708 (e.g., a first bushing assembly) couples the shackle 704 to the leaf spring 702, and a second fastener 710 (e.g., a second bushing assembly) couples the shackle 704 to the frame 706. As such, the first fastener 708 serves as a shackle-to-leaf spring joint, and the second fastener 710 serves as a shackle-to-frame joint. The shackle 704 pivots from a change in a load being supported by the vehicle.

In the illustrated example of FIG. 7, a plate 712 is coupled to the shackle 704 via another fastener 714. Specifically, the fastener 714 extends at least partially through a surface 716 of the shackle 704 that faces a lateral direction. Further, the accelerometer 102 is coupled to the plate 712. The accelerometer 102 is positioned on a side of the shackle 704 opposite the leaf spring 702. For example, the accelerometer 102 can be positioned rearward of the leaf spring 702 and the shackle 704 (e.g., rearward of a rear end of the leaf spring 702, rearward of a rearward facing surface of the shackle 704). As such, the accelerometer 102 of FIG. 7 is not aligned with the leaf spring 702 nor the shackle 704 in a longitudinal direction defined by the vehicle, which enables the accelerometer 102 to have more space for movement (e.g., encounter an increased angular rotation) while avoiding contact with the leaf spring 702, the shackle 704, and/or the frame 706 as the suspension system 700 moves. Advantageously, the increased space for movement enables weight estimations associated with the movement of the accelerometer 102 to have an increased sensitivity.

FIG. 8 illustrates the example suspension system 700 including another example location 801 for the accelerometer 102 to facilitate a vehicle load determination. In the illustrated example of FIG. 8, the accelerometer 102 is coupled to the shackle 704 via a fastener 802. That is, the fastener 802 couples directly to the shackle 704 and to the accelerometer 102. In this example, the fastener 802 is implemented by a J-clip, nut, and bolt assembly (e.g., the J-clip 202, nut 204, and bolt 206 of FIG. 2). As such, fewer and/or smaller components can be utilized to couple the accelerometer 102 to the shackle 704 relative to the example accelerometer location 701 of FIG. 7.

In the illustrated example of FIG. 8, the accelerometer 102 is positioned on and/or coupled to a surface 804 of the shackle 704 facing a longitudinal direction defined by the vehicle (e.g., a frontward facing surface). The accelerometer 102 is aligned with a portion of the leaf spring 702 in a longitudinal direction defined by the vehicle. Further, the accelerometer 102 is positioned between the first fastener 708 and the second fastener 710 and, thus, between a first end and a second end of the shackle 704 in a vertical direction defined by the vehicle.

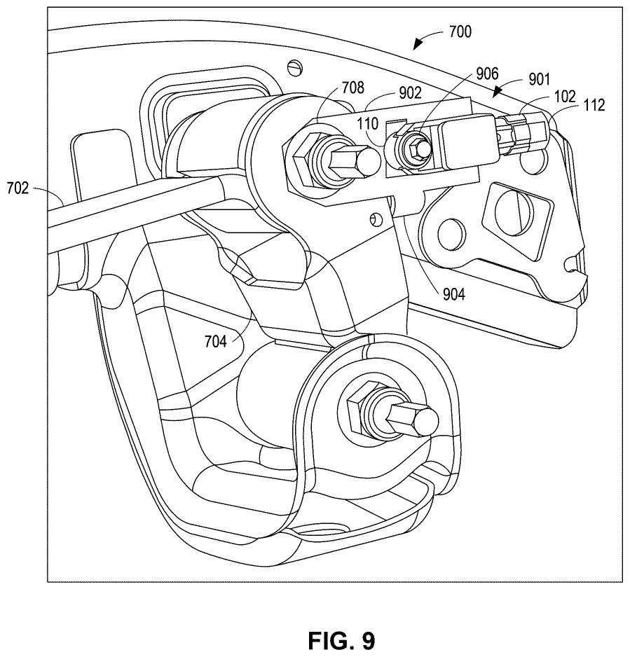

FIG. 9 illustrates the example suspension system 700 including another example location 901 for the accelerometer 102 to facilitate a vehicle load determination. In the illustrated example of FIG. 9, a washer 902 is coupled to the shackle 704 via the first fastener 708 that couples the leaf spring 702 to the shackle 704. The washer 902 includes a projection 904 (e.g., a tab) to limit a rotation of the washer 902 when coupling the fastener 708 to the shackle 704. Specifically, the projection 904 contacts the shackle 704 to block the washer 902 from rotating as the fastener 708 couples the leaf spring 702 to the shackle 704 (e.g., as a nut or bolt associated with the fastener 708 is tightened against the washer 902 and/or the shackle 704). In the illustrated example of FIG. 9, the accelerometer 102 is coupled to the washer 902 via a third fastener 906. As such, an axis about which the accelerometer 102 pivots is co-axial with the fastener 708 that couples the leaf spring 702 to the shackle 704. In this example, the third fastener 906 is implemented by a J-clip nut and bolt assembly (e.g., the J-clip 202, nut 204, and bolt 206 of FIG. 2). In the illustrated example of FIG. 9, the accelerometer 102 is disposed at an angle that positions at least a portion of the second end 112 of the accelerometer 102 above the first end 110.

In the illustrated example of FIGS. 7, 8, and 9, when the vehicle associated with the suspension system 700 encounters a load change, the shackle 704 and, in turn, the accelerometer 102 moves (e.g., pivots, rotates, translates, etc.) relative to the frame 706 of the vehicle at a magnitude directly related to (e.g., proportional to) the load change. For example, the shackle 704 and the accelerometer 102 can move relative to (e.g., pivot and/or rotate about) the second fastener 710 based on the load in the illustrated example of FIGS. 7, 8, and/or 9. Additionally, in the illustrated example of FIG. 9, the accelerometer 102 pivots about the first fastener 708 based on the load. As such, a position (e.g., an angular dislocation, a linear dislocation, etc.) of the accelerometer 102 relative to the first fastener 708 and/or the second fastener 710 is indicative of the load being supported by one or more wheels of the vehicle proximate the accelerometer 102 (e.g., a left rear wheel(s) or a right rear wheel(s) of the vehicle). In the illustrated examples of FIGS. 7 and/or 9, at least a portion of the accelerometer 102 moves upwards as a load supported by the vehicle increases.

The locations 701, 901 of the accelerometer 102 of FIGS. 7 and 9 help protect the accelerometer 102 from off-road debris. Specifically, as the locations 701, 901 of the accelerometer 102 are behind the rear end of the leaf spring 702 and the shackle 704, the leaf spring 702 and the shackle 704 can deflect debris away from the accelerometer 102.

While such protection is reduced in the location 801 of FIG. 8, the location 801 avoids usage of an extra plate/bracket (e.g., the plate 712, the washer 902) to couple the accelerometer 102 to the shackle 704. Accordingly, the location 801 facilitates easier vehicle assembly by reducing efforts associated with coupling to the accelerometer 102 to the shackle 704. Additionally, the location 801 of FIG. 8 enables a reduced space to be reserved for travel of the accelerometer 102 as a result of loading. Accordingly, the location 801 reduces constraints on positioning of vehicle components around the shackle 704.

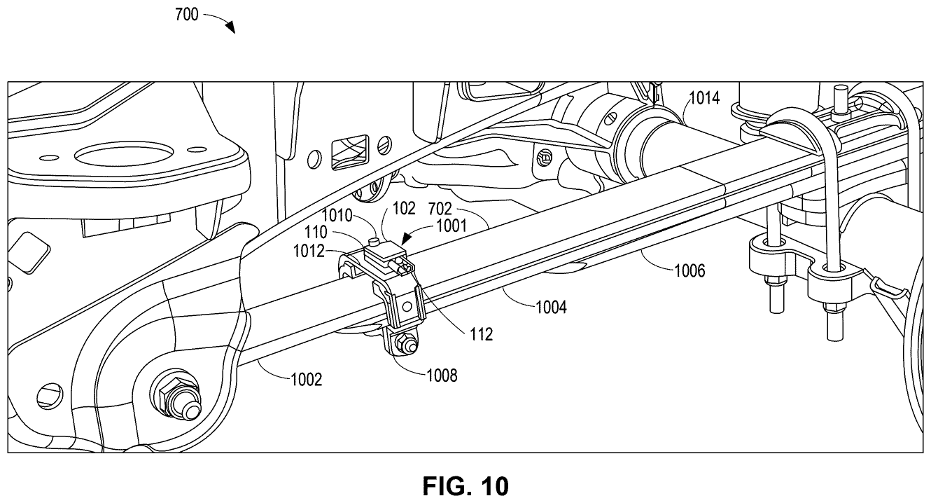

FIG. 10 illustrates the example suspension system 700 including another example location 1001 for the accelerometer 102 to facilitate a vehicle load determination. In the illustrated example of FIG. 10, the accelerometer 102 is coupled to the leaf spring 702. Specifically, the leaf spring 702 is a multi-leaf spring that includes a plurality of leaves 1002, 1004, 1006 (e.g., plates, springs) and a clinch clip 1008 (e.g., a front clinch clip) that controls a splay of the leaves 1002, 1004, 1006. In this example, the leaf spring 702 includes a top spring 1002, a middle spring 1004, and a bottom spring 1006. The clinch clip 1008 couples (e.g., clamps) the top spring 1002 and the middle spring 1004.

In the illustrated example of FIG. 10, the accelerometer 102 is coupled to the clinch clip 1008 via a fastener 1010 (e.g., a bolt). Specifically, the clinch clip 1008 includes an upper plate 1012, and the fastener 1010 is inserted through the upper plate 1012 and the accelerometer 102. The accelerometer 102 is positioned above the top spring 1002 and the upper plate 1012 of the clinch clip 1008. Advantageously, coupling the accelerometer 102 to the clinch clip 1008, as opposed to coupling directly to the top spring 1002, enables the accelerometer 102 to be coupled to the leaf spring 702 without a hole being formed in the top spring 1002 (e.g., a main plate of the leaf spring 702) for the coupling, which would otherwise reduce an amount of stress that the leaf spring 702 can withstand. The locations 701, 801, 901 similarly provide a rear suspension location for the accelerometer 102 that reduces localized stress in the top spring 1002. Additionally, the location 1001 of the accelerometer 102 of FIG. 10 is above the leaf spring 702 protects the accelerometer 102 from off-road obstacles and/or debris. In the illustrated example of FIG. 10, the accelerometer 102 is disposed at an angle that positions at least a portion of the second end 112 of the accelerometer 102 above the first end 110.

In the illustrated example of FIG. 10, the accelerometer 102 is coupled to a front portion of the leaf spring 702. Specifically, the leaf spring 702 is coupled to a rear axle 1014 of the vehicle, and the accelerometer 102 is positioned closer than the rear axle 1014 to a front of the vehicle. Additionally, the accelerometer 102 is positioned closer than the bottom spring 1006 to the front of the vehicle. As a result, the accelerometer 102 encounters a desired magnitude of movement to facilitate a vehicle load determination with a desired level of granularity. In some instances, if the accelerometer 102 were to couple to the portion of the leaf spring 702 that aligns with a longitudinal span of the bottom leaf 1006, the accelerometer 102 would encounter less angular movement in response to a change in load encountered by the vehicle and, thus, may not be able to detect relatively smaller load changes, thereby reducing an accuracy of the load estimation.

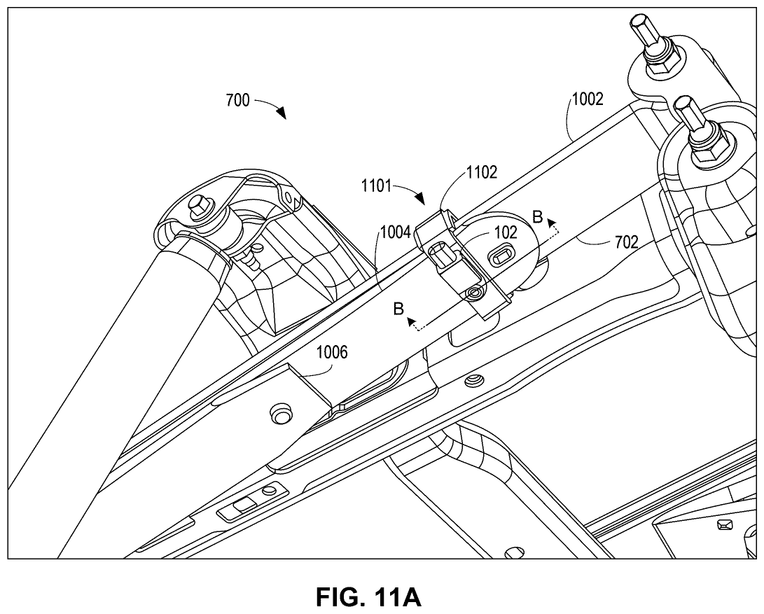

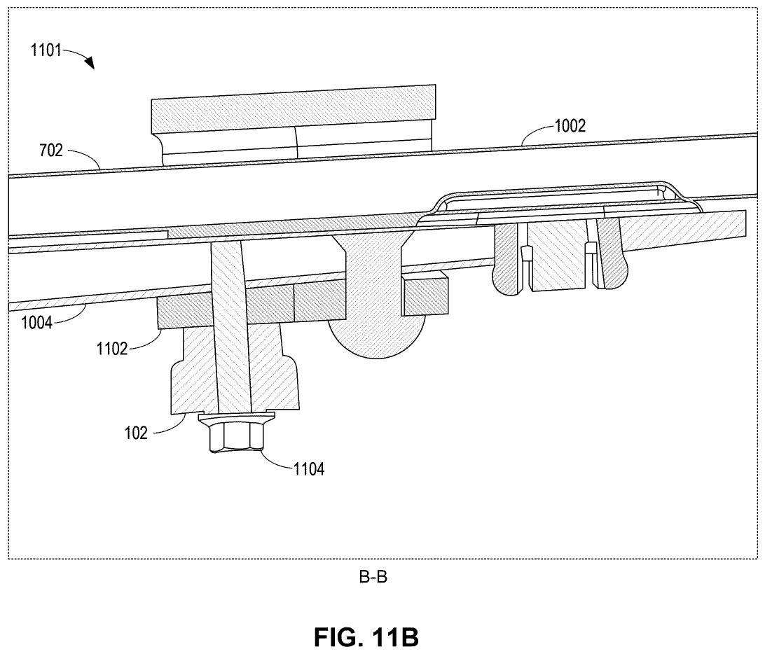

FIG. 11A illustrates the example suspension system 700 including another example location 1101 for the accelerometer 102 to facilitate a vehicle load determination. In the illustrated example of FIG. 11A, the accelerometer 102 is coupled to the leaf spring 702. Specifically, the accelerometer 102 is coupled to another clinch clip 1102 (e.g., a rear clinch clip) that couples (e.g., clamps) the top spring 1002 and the middle spring 1004. In the illustrated example of FIG. 11A, the accelerometer 102 is positioned below the top spring 1002, the middle spring 1004, and the clinch clip 1102. Specifically, the clinch clip 1102 includes a double sided stud (not shown) that extends through opposite lateral portions of the clinch clip 1102. Nuts are coupled to opposite ends of the double sided stud to push the opposite lateral portions of the clinch clip 1102 together thereby causing the clinch clip 1102 to clamp the top spring 1002 and the middle spring 1004 together.

In the illustrated example of FIG. 11A, the accelerometer 102 is coupled to a rear portion of the leaf spring 702. Specifically, the accelerometer 102 is positioned closer than the rear axle 1014 and the bottom spring 1006 to a rear of the vehicle (e.g., is positioned rearward of the rear axle 1014 and the bottom spring 1006). The location 1101 of the accelerometer 102 causes the accelerometer 102 to encounter a desired magnitude of movement to facilitate a vehicle load determination with a desired level of granularity. The location 1101 of the accelerometer 102 on rear portion and underside of the leaf spring 702 enables easier assembly of the accelerometer 102 to the leaf spring 702. Further, the location 1101 of the accelerometer 102 on the rear portion and underside of the leaf spring 702 enables the accelerometer 102 to be protected from contacting debris and/or obstacles by other components of the vehicle.

FIG. 11B illustrates a cross-sectional view of the location 1101 for the accelerometer 102 taken along line B-B of FIG. 11A. In the illustrated example of FIG. 11B, the accelerometer 102 is coupled to the clinch clip 1102 via a fastener 1104. The fastener 1104 extends through at least a portion of the middle spring 1004 to secure a position of the accelerometer 102. As such, the fastener 1104 maintains the position of the accelerometer 102 relative to the leaf spring 702. Advantageously, the fastener 1104 enables the position of the accelerometer 102 relative to the leaf spring 702 to be maintained without puncturing the top spring 1002, which would otherwise reduce an amount of stress that the leaf spring 702 can withstand.

FIG. 12A illustrates an example vehicle 1200 including or communicatively coupled to example sensor position analysis circuitry 1202 in accordance with teachings of this disclosure. In the illustrated example of FIG. 12A, the vehicle 1200 is a truck. In some examples, the vehicle 1200 can be a different type of vehicle (e.g., a sedan, a van, a sport utility vehicle (SUV), etc.). In the example of FIG. 12A, the vehicle 1200 includes a first wheel 1204A (e.g., a left front (LF) wheel), a second wheel 1204B (e.g., a right front (RF) wheel), a third wheel 1204C (e.g., a left rear (LR) wheel), and a fourth wheel 1204D (e.g., a right rear (RR) wheel).

In the illustrated example of FIG. 12A, the vehicle 1200 includes example suspension systems 1206A, 1206B, 1206C, 1206D operatively coupled to respective ones of the wheels 1204A, 1204B, 1204C, 1204D. For example, the vehicle 1200 includes a first suspension system 1206A operatively coupled to the first wheel 1204A, a second suspension system 1206B operatively coupled to the second wheel 1204B, a third suspension system 1206C operatively coupled to the third wheel 1204C, and a fourth suspension system 1206D operatively coupled to the fourth wheel 1204D. In the illustrated example of FIG. 12A, the first suspension system 1206A and the second suspension system 1206B are example independent front suspension systems that can be implemented by the example suspension system 100 of FIGS. 1 and 3 and/or the example suspension system 400 of FIGS. 4, 5, and 6 (e.g., double wishbone suspension systems short-long arm (SLA) suspension systems). In the illustrated example of FIG. 12A, the third suspension system 1206C and the fourth suspension system 1206D are example rear suspension systems that can be implemented by the example suspension system 700 of FIGS. 7, 8, 9, 10, and 11 (e.g., Hotchkiss rear suspension systems, leaf spring suspension systems).

In the illustrated example of FIG. 12A, the vehicle 1200 also includes accelerometers 102A, 102B, 102C, 102D (e.g., suspension accelerometers) operatively coupled to respective ones of the suspension systems 1206A, 1206B, 1206C, 1206D. Specifically, the accelerometers 102A, 102B are coupled to the example suspension systems 1206A, 1206B in the example location 101 of FIG. 1, the example location 301 of FIG. 3, the example location 401 of FIG. 4, the example location 501 of FIG. 5, and/or the example location 601 of FIG. 6. Further, the accelerometers 102C, 102D are coupled to the example suspension systems 1206C, 1206D in the example location 701 of FIG. 7, the example location 801 of FIG. 8, the example location 901 of FIG. 9, the example location 1001 of FIG. 10, and/or the example location 1101 of FIG. 11. In the illustrated example of FIG. 12A, the vehicle 1200 further includes an example body accelerometer 1208 (e.g., a vehicle body sensor) fixedly coupled to a body 1210 of the vehicle 1200. The accelerometers 102A, 102B, 102C, 102D and the body accelerometer 1208 are tri-axis accelerometers that measure acceleration (e.g., an x-acceleration, a y-acceleration, and a z-acceleration) along three dimensions and/or axes (e.g., an x-axis, a y-axis, and a z-axis).

In the illustrated example of FIG. 12A, the body accelerometer 1208 measures acceleration of the body 1210 of the vehicle 1200 with respect to a body sensor coordinate system 1212 positioned at (e.g., with an origin at) the body accelerometer 1208. For example, the body accelerometer 1208 measures a body sensor x-acceleration along a body sensor x-axis 1214A of the body sensor coordinate system 1212, a body sensor y-acceleration along a body sensor y-axis 1214B of the body sensor coordinate system 1212, and/or a body sensor z-acceleration along a body sensor z-axis 1214C of the body sensor coordinate system 1212.

Further, the accelerometers 102A, 102B, 102C, 102D measure acceleration relative to a respective sensor coordinate systems 1216, one of which is shown in FIG. 12A. For example, the sensor coordinate system 1216 shown in FIG. 12A is positioned at (e.g., has an origin at) the first suspension accelerometer 102A, such that the first suspension accelerometer 102A measures a sensor x-acceleration along a sensor x-axis 1218A of the sensor coordinate system 1216, a sensor y-acceleration along a sensor y-axis 1218B of the sensor coordinate system 1216, and/or a sensor z-acceleration along a sensor z-axis 1218C of the sensor coordinate system 1216. While only one of the sensor coordinate systems 1216 is shown in FIG. 12A, additional sensor coordinate systems 1216 are positioned at respective ones of the accelerometers 102B, 102C, 102D.

The measured accelerations for particular one(s) of the accelerometers 102A, 102B, 102C, 102D can be described with respect to a different coordinate system (e.g., the body sensor coordinate system 1212, a different one of the sensor coordinate systems 1216, and/or to an example global coordinate system 1220 of the vehicle 1200). In this example, the global coordinate system 1220 is defined by a global x-axis 1222A (e.g., a longitudinal axis), a global y-axis 1222B (e.g., a lateral axis), and a global z-axis 1222C (e.g., a vertical axis). In the example of FIG. 12A, the global coordinate system 1220 is a fixed coordinate system (e.g., at a fixed position and/or orientation) with the global z-axis 1222C substantially parallel to a direction of gravity.

In this example, the body accelerometer 1208 is fixedly coupled to the vehicle body 1210, such that the body accelerometer 1208 can rotate with the vehicle body 1210 relative to the global coordinate system 1220. The accelerometers 102A, 102B, 102C, 102D are coupled to movable components of the respective suspension systems 1206A, 1206B, 1206C, 1206D, such that the accelerometers 102A, 102B, 102C, 102D can move (e.g., rotate and/or translate) relative to the vehicle body 1210.

In the illustrated example of FIG. 12A, the suspension accelerometers 102A, 102B, 102C, 102D and the body accelerometer 1208 are communicatively coupled to the example sensor position analysis circuitry 1202 to provide sensor data (e.g., the measured acceleration(s)) to the sensor position analysis circuitry 1202. The example sensor position analysis circuitry 1202 analyzes the outputs of the suspension accelerometers 102A, 102B, 102C, 102D and the body accelerometer 1208 when the vehicle body 1210 is supporting different loads to determine, or enable a determination of, optimal locations for the suspension accelerometers 102A, 102B, 102C, 102D. For example, the vehicle 1200 can correspond to a test vehicle that is utilized to facilitate the determination of the optimal locations for the suspension accelerometers 102A, 102B, 102C, 102D by the sensor position analysis circuitry 1202, and the determined optimal locations can then be implemented in production of the vehicle 1200 and/or the suspension systems 1206A, 1206B, 1206C, 1206D. For example, when the suspension systems 1206A, 1206B correspond to the suspension system 400 of FIGS. 4-6, the accelerometers 102A, 102B can be tested in the location 401 of FIG. 4, the location 501 of FIG. 5, and/or the location 601 of FIG. 6 to determine which location is preferable for the vehicle 1200 and/or the suspension systems 1206A, 1206B. Similarly, when the suspension systems 1206A, 1206B correspond to the suspension system 100 of FIGS. 1 and 3, the accelerometers 102A, 102B can be tested in the location 101 of FIG. 1 and the location 301 of FIG. 3 to determine which is preferable for the vehicle 1200 and/or the suspension systems 1206A, 1206B. Further, when the suspension systems 1206C, 1206D correspond to the suspension system 700 of FIGS. 7-11B, the accelerometers 102C, 102D can be tested in the locations 701, 801, 901, 1001, 1101 of FIGS. 7, 8, 9, 10, and/or 11A-11B to determine which is preferable for the vehicle 1200 and/or the suspension systems 1206C, 1206D.

In some examples, to facilitate the determination of the optimal locations for the suspension accelerometers 102A, 102B, 102C, 102D, the sensor position analysis circuitry 1202 determines mass estimation error data (e.g., in kg) and/or measurement sensitivity data (e.g., in kg/degree). The sensor position analysis circuitry 1202 can communicate the mass estimation error data and/or the measurement sensitivity data to example user interface circuitry 1224 and/or example assembly circuitry 1226. As a result, the assembly circuitry 1226 can cause the determined optimal accelerometer locations to be implemented in vehicles (e.g., ones of the vehicle 1200) to be assembled for sale. For example, the assembly circuitry 1226 can cause manufacturing machines that couple the accelerometers 102A, 102B, 102C, 102D to a plurality of the vehicle 1200 for subsequent sale and/or distribution to position the accelerometers 102A, 102B, 102C, 102D based on the determined mass estimation error data and/or the determined measurement sensitivity data. Additionally or alternatively, the user interface circuitry 1224 can present the mass estimation error data and/or the measurement sensitivity data to a user that can then cause the optimal accelerometer locations to be implemented in the plurality of the vehicle 1200 to be assembled for sale.

FIG. 12B shows an example implementation of the accelerometer 102A operatively coupled to the suspension system 1206A. The accelerometer 102A of FIG. 12B can be in the example location 101 of FIG. 1, the example location 301 of FIG. 3, the example location 401 of FIG. 4, and/or the example location 501 of FIG. 5. The illustrated example of FIG. 12B also shows a hardpoint 1252, which corresponds to the body 1210 of the vehicle 1200. A position (e.g., x, y, z coordinates) of the hardpoint 1252 can be derived from an output of the body accelerometer 1208. A fastener 1254 coupled to an end of the suspension system 1206A opposite the hardpoint 1252 can correspond to a hub associated with the first wheel 1204A of FIG. 12A.

When the vehicle 1200 is loaded, the suspension system 1206A pivots from an unloaded position 1256 to a loaded position 1258. The sensor position analysis circuitry 1202 identifies an angular change of the accelerometer 102A that can be utilized to calculate a load carried by the vehicle 1200. Specifically, the sensor position analysis circuitry 1202 ignores an x-component of the coordinates associated with the hardpoint 1252 and the accelerometer 102A. Further, the sensor position analysis circuitry 1202 can plot the y and z-coordinates of (i) the hardpoint 1252, (ii) the accelerometer 102A in the unloaded position 1256, and (iii) the accelerometer 102A in the loaded position 1258 to determine the angle change encountered by the accelerometer 102A.

For example, when the coordinates of the hardpoint 1252 are (1650, −325, 400), the coordinates of the accelerometer 102A in the unloaded position 1256 are (1500, −450, 400), and the coordinates of the accelerometer 102A in the loaded position 1258 are (1500, −449, 425), the sensor position analysis circuitry 1202 can plot a first 2-dimensional vector that corresponds to the y and z-coordinates from the hardpoint 1252 to the accelerometer 102A in the unloaded position 1256 and plot a second 2-dimensional vector that corresponds to the y and z-coordinates from the hardpoint 1252 to the accelerometer 102A in the loaded position 1258. Accordingly, the y and z-coordinates of the hardpoint 1252 serve as a vertex of the first and second vectors. The sensor position analysis circuitry 1202 can digitally measure the angle change between the vectors. Further, the sensor position analysis circuitry 1202 can determine the weight of the vehicle 1200 based on the measured angle change.

FIG. 12C is a schematic representation of another example implementation of the suspension system 1206A and/or the suspension system 1206B of FIG. 12A. In the illustrated example of FIG. 12C, the suspension system 1206A and/or the suspension system 1206B are implemented by the suspension system 400 of FIGS. 4-6, and the accelerometer 102A, 102B is in the location 601 of FIG. 6. That is, the accelerometer 102A is coupled to the lower strut joint 604 (e.g., a knuckle strut joint). Alternatively, the accelerometer 102A can be coupled to the knuckle 606 of FIG. 6. For example, the accelerometer 102A can be coupled to a knuckle lower ball joint 1262 or a knuckle tie rod joint 1264.

When the accelerometer 102A is coupled to the lower strut joint 604, the knuckle lower ball joint 1262, or the knuckle tie rod joint 1264, the accelerometer 102A moves with more than one degree of freedom when the weight of the vehicle 1200 changes. Specifically, the accelerometer 102A encounters translation about a line of the strut tube 608, rotation about the rotational axis 624 of the lower control arm 404 (FIGS. 4-6), and pivoting about a knuckle axis 1266 as a result of input from a tie rod that is controlled by a steering system associated with the vehicle 1200.

As such, the sensor position analysis circuitry 1202 performs additional computations to convert an observed gravitational vector measured by the accelerometer 102A into a position of the lower strut joint 604, the knuckle lower ball joint 1262, or the knuckle tie rod joint 1264. The determined position of the lower strut joint 604, the knuckle lower ball joint 1262, or the knuckle tie rod joint 1264 can then be utilized to determine a force acting on the suspension system 400 and, thus, a weight supported by the suspension system 1206A. The sensor position analysis circuitry 1202 utilizes a system of equations and predetermined data or values corresponding to: an upper strut location (point a₁, b₁, c₁ of FIG. 12C); a lower spring location (point a₂, b₂, c₂ of FIG. 12C); a control arm center of rotation (point f₁, g₁, h₁ of FIG. 12C); a control arm rear fastener point (point f₂, g₂, h₂ of FIG. 12C); an inner tie rod end (point u, v, w of FIG. 12C); a control arm length (distance r₁ of FIG. 12C); a knuckle length, bottom to top (distance r₂ of FIG. 12C); a knuckle length, bottom to side (distance r₃ of FIG. 12C); a knuckle length, side to top (distance r₃ of FIG. 12C); and a tie rod length (distance r₅ of FIG. 12C) to solve for: a location of the knuckle lower ball joint 1262 (point x₁, y₁, z₁ of FIG. 12C); a location of the lower strut joint 604 (point x₂, y₂, z₂ of FIG. 12C); and a location of the knuckle tie rod joint 1264 (point x₃, y₃, z₃ of FIG. 12C). The system of equations is partially represented by Equations 1-7 below.

$${( {x}_{1} - {f}_{1} )}^{2} + {( {y}_{1} - {g}_{1} )}^{2} + {( {z}_{1} - {h}_{1} )}^{2} = {r}_{1}^{2} \qquad ( Equation 1 )$$

$${( {x}_{2} - {x}_{1} )}^{2} + {( {y}_{2} - {y}_{1} )}^{2} + {( {z}_{2} - {z}_{1} )}^{2} = {r}_{2}^{2} \qquad ( Equation 2 )$$

$${( {x}_{3} - {x}_{1} )}^{2} + {( {y}_{3} - {y}_{1} )}^{2} + {( {z}_{3} - {z}_{1} )}^{2} = {r}_{3}^{2} \qquad ( Equation 3 )$$

$${( {x}_{3} - {x}_{2} )}^{2} + {( {y}_{3} - {y}_{2} )}^{2} + {( {z}_{3} - {z}_{2} )}^{2} = {r}_{4}^{2} \qquad ( Equation 4 )$$

$${( {x}_{3} - u )}^{2} + {( {y}_{3} - v )}^{2} + {( {z}_{3} - w )}^{2} = {r}_{5}^{2} \qquad ( Equation 5 )$$

$$( {f}_{2} - {f}_{1} ) ( {x}_{1} - {f}_{1} ) + ( {g}_{2} - {g}_{1} ) ( {y}_{1} - {g}_{1} ) + ( {h}_{2} - {h}_{1} ) ( {z}_{1} - {h}_{1} ) = 0 \qquad ( Equation 6 )$$

$$( ( {b}_{2} - {b}_{1} ) ( {c}_{1} - {z}_{2} ) - ( {c}_{2} - {c}_{1} ) ( {b}_{1} - {y}_{2} ) ) + ( ( {c}_{2} - {c}_{1} ) ( {a}_{1} - {x}_{2} ) - ( {a}_{2} - {a}_{1} ) ( {c}_{1} - {z}_{2} ) ) + ( ( {a}_{2} - {a}_{1} ) ( {b}_{1} - {y}_{2} ) - ( {b}_{2} - {b}_{1} ) ( {a}_{1} - {x}_{2} ) ) = 0 \qquad ( Equation 7 )$$

Further, the remaining equations of the system of equations are represented by Equations 8-9 below. In Equations 8-9, α and β are obtained through the measurement by the accelerometer 102A and are in the form of unit vectors (i.e., direction in the global coordinate system 1220 of FIG. 12A). Specifically, α is representative of the unit vector from the knuckle lower ball joint 1262 to the lower strut joint 604, and β is representative of the unit vector from the knuckle lower ball joint 1262 to the knuckle tie rod joint 1264. One of the unit vectors (e.g., α) can correspond to the output of the accelerometer 102A, and the other unit vector (e.g., β) can be determined based on the output of accelerometer 102A and the known quantities, such as a comparison to global gravity (e.g., via an output of the body accelerometer 1208) and a known orientation of the knuckle at the rated position.

$$\frac{( {x}_{2} - {x}_{1} )}{{r}_{2}} i + \frac{( {y}_{2} - {y}_{1} )}{{r}_{2}} j + \frac{( {z}_{2} - {z}_{1} )}{{r}_{2}} k = {α}_{x} i + {α}_{y} j + {α}_{z} k \qquad ( Equation 8 )$$

$$\frac{( {x}_{3} - {x}_{1} )}{{r}_{3}} i + \frac{( {y}_{3} - {y}_{1} )}{{r}_{3}} j + \frac{( {z}_{3} - {z}_{1} )}{{r}_{3}} k = {β}_{x} i + {β}_{y} j + {β}_{z} k \qquad ( Equation 9 )$$

The sensor position analysis circuitry 1202 utilizes Equations 1-9 to solve for unknown variables including the location of the location of the knuckle lower ball joint 1262 (point x₁, y₁, z₁ of FIG. 12C); the lower strut joint 604 (point x₂, y₂, z₂ of FIG. 12C); and the location of the knuckle tie rod joint 1264 (point x₃, y₃, z₃ of FIG. 12C). As a result, the knuckle location and orientation in three-dimensional space can be determined, thereby enabling calculation of the forces acting on the suspension system 1206A.

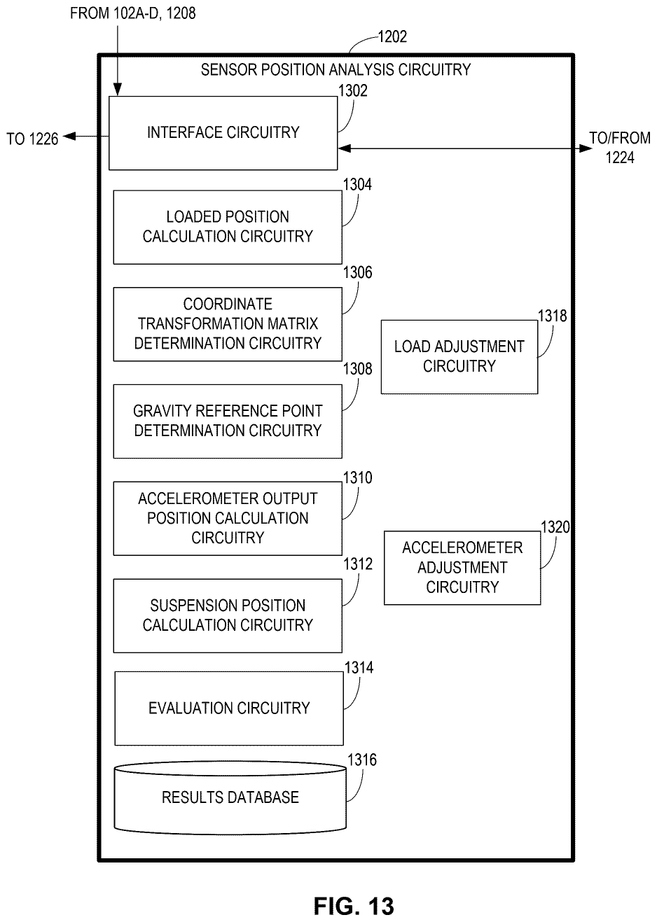

FIG. 13 is a block diagram of an example implementation of the sensor position analysis circuitry 1202 of FIG. 12A to analyze outputs of the suspension accelerometers 102A, 102B, 102C, 102D when different loads are being supported by the vehicle 1200 to determine, and/or enable a determination of, optimal locations for the accelerometers 102A, 102B, 102C, 102D in the vehicle 1200 and/or the associated suspension systems 1206A, 1206B, 1206C, 1206D. The sensor position analysis circuitry 1202 may be instantiated (e.g., creating an instance of, bring into being for any length of time, materialize, implement, etc.) by programmable circuitry such as a Central Processor Unit (CPU) executing first instructions. Additionally or alternatively, the sensor position analysis circuitry 1202 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIGS. 12 and/or 13 may, thus, be instantiated at the same or different times. Some or all of the circuitry of FIGS. 12 and/or 13 may be instantiated, for example, in one or more threads executing concurrently on hardware and/or in series on hardware. Moreover, in some examples, some or all of the circuitry of FIGS. 12A and/or 13 may be implemented by microprocessor circuitry executing instructions and/or FPGA circuitry performing operations to implement one or more virtual machines and/or containers.

In the illustrated example of FIG. 13, the example sensor position analysis circuitry 1202 includes example interface circuitry 1302, example loaded position calculation circuitry 1304, example coordinate transformation matrix determination circuitry 1306, example gravity reference point determination circuitry 1308, example accelerometer output position calculation circuitry 1310, example suspension position calculation circuitry 1312, example evaluation circuitry 1314, an example database 1316, example load adjustment circuitry 1318, and example accelerometer adjustment circuitry 1320.

In the illustrated example of FIG. 13, the interface circuitry 1302 obtains, accesses, and/or receives example input data utilized by the sensor position analysis circuitry 1202 to determine example mass estimation error data, example measurement sensitivity data, and/or example optimal sensor location data associated with the respective accelerometers 102A, 102B, 102C, 102D and the respective positions in which the accelerometers 102A, 102B, 102C, 102D are implemented in the vehicle 1200. Further, the interface circuitry 1302 can deliver (e.g., transmit) the example mass estimation error data, the example measurement sensitivity data, and/or the example optimal sensor location data to the user interface circuitry 1224 and/or the assembly circuitry 1226 of FIG. 12A. Accordingly, the interface circuitry 1302 can be communicatively coupled to the suspension accelerometers 102A, 102B, 102C, 102D, the body accelerometer 1208, the user interface circuitry 1224 and/or the assembly circuitry 1226.

The interface circuitry 1302 obtains example suspension sensor data from respective one(s) of the suspension accelerometers 102A, 102B, 102C, 102D. The suspension sensor data can include measurement values (e.g., in meters per second per second (m/s²)) representative of the acceleration of the respective suspension accelerometers 102A, 102B, 102C, 102D in three directions (e.g., along the sensor x-axis 1218A, the sensor y-axis 1218B, and the sensor z-axis 1218C of the respective sensor coordinate systems 1216 of FIG. 12A). In some examples, the interface circuitry 1302 obtains example body sensor data from the body accelerometer 1208. In some examples, the body sensor data includes measurement values (e.g., in m/s²) representative of an acceleration(s) of the body accelerometer 1208 along the body sensor x-axis 1214A, the body sensor y-axis 1214B, and the body sensor z-axis 1214C of the body sensor coordinate system 1212 of FIG. 12A.

Additionally, the interface circuitry 1302 obtains reference data associated with the vehicle 1200. In some examples, the interface circuitry 1302 obtains, accesses, and/or receives the upper strut location (point a₁, b₁, c₁ of FIG. 12C); the lower spring location (point a₂, b₂, c₂ of FIG. 12C); the control arm center of rotation (point f₁, g₁, h₁ of FIG. 12C); a control arm rear fastener point (point f₂, g₂, h₂ of FIG. 12C); the inner tie rod end (point u, v, w of FIG. 12C); the control arm length (distance r₃ of FIG. 12C); the knuckle length, bottom to top (distance r₂ of FIG. 12C); the knuckle length, bottom to side (distance r₃ of FIG. 12C); the knuckle length, side to top (distance r₃ of FIG. 12C); and the tie rod length (distance r₅ of FIG. 12C). Further, the reference data can include example rated positions (e.g., design positions, initial positions) of the suspension accelerometers 102A, 102B, 102C, 102D. For example, the rated positions for the respective suspension accelerometers 102A, 102B, 102C, 102D can include an origin rated point, an x-axis rated reference point, a y-axis rated reference point, a z-axis rated reference point, a first rotation point, a second rotation point, an angle from a rebound position (e.g., a lowest point of travel for the respective suspension accelerometer 102A, 102B, 102C, 102D) to the rated position, and/or an angular travel of the suspension accelerometer 102A, 102B, 102C, 102D in degrees and/or radians. The origin rated point is defined as coordinates (e.g., [x, y, z] in the global coordinate system 1220) where the suspension accelerometer 102A, 102B, 102C, 102D measures acceleration in the rated position. The x-axis rated reference point corresponds to coordinates (e.g., [x, y, z] in the global coordinate system 1220) along the sensor x-axis 1218A in the rated position. For example, in the respective sensor coordinate system 1216, the x-axis rated reference point can be [10 millimeters (mm), 0 mm, 0 mm]. The y-axis rated reference point corresponds to coordinates (e.g., [x, y, z] in the global coordinate system 1220) along the sensor y-axis 1218B in the rated position. For example, in the respective sensor coordinate system 1216, the y-axis rated reference point can be [0 mm, 10 mm, 0 mm]. The z-axis rated reference point corresponds to coordinates (e.g., [x, y, z] in the global coordinate system 1220) along the sensor z-axis 1218C in the rated position. For example, in the respective sensor coordinate system 1216, the z-axis rated reference point can be [0 mm, 0 mm, 10 mm]. The first rotation point corresponds to first coordinates (e.g., [x, y, z] in the global coordinate system 1220) of two sets of coordinates that define a primary axis of rotation about which the respective accelerometer 102A, 102B, 102C, 102D rotates (e.g., coordinates of the first fastener 304 of FIG. 3 in the global coordinate system 1220, coordinates of the first fastener 618 of FIGS. 4-6 in the global coordinate system 1220, etc.). Similarly, the second rotation point corresponds to second coordinates (e.g., [x, y, z] in the global coordinate system 1220) of the two sets of coordinates that define the primary axis of rotation about which the respective accelerometer 102A, 102B, 102C, 102D rotates (e.g., coordinates of the second fastener 306 of FIG. 3 in the global coordinate system 1220, coordinates of the second fastener 620 of FIGS. 4-6 in the global coordinate system 1220, etc.). The angle from the rebound position to the rated position can correspond to an angle (e.g., in radians) about the primary axis of rotation from the rebound position to the rated position for the particular suspension system 1206A, 1206B, 1206C, 1206D. Although the example accelerometer position analysis discussed in FIG. 13 is performed in connection with the rebound position, it should be understood that another position between the rebound position and the rated position can be substituted for the rebound position.

In some examples, the interface circuitry 1302 obtains, accesses, and/or receives an identifier associated with a respective location (e.g., the location 101 of FIG. 1, the location 301 of FIG. 3, the location 401 of FIG. 4, the location 501 of FIG. 5, the location 601 of FIG. 6, the location 701 of FIG. 7, the location 801 of FIG. 8, the location 901 of FIG. 9, the location 1001 of FIG. 10, the location 1101 of FIG. 11) of the accelerometer 102A, 102B, 102C, 102D. In some examples, the interface circuitry 1302 obtains, accesses, and/or receives a second identifier associated with a particular micro electromechanical system associated with the accelerometer 102A, 102B, 102C, 102D (e.g., a type of the accelerometer 102A, 102B, 102C, 102D). In some examples, the interface circuitry 1302 obtains, accesses, and/or receives a preferred evaluation metric associated with the determination of a preferable accelerometer location and/or type. For example, the preferred evaluation metric can be based on a preferable (e.g., a lowest) mass estimation error associated with a certain load (e.g., a GAWR load).

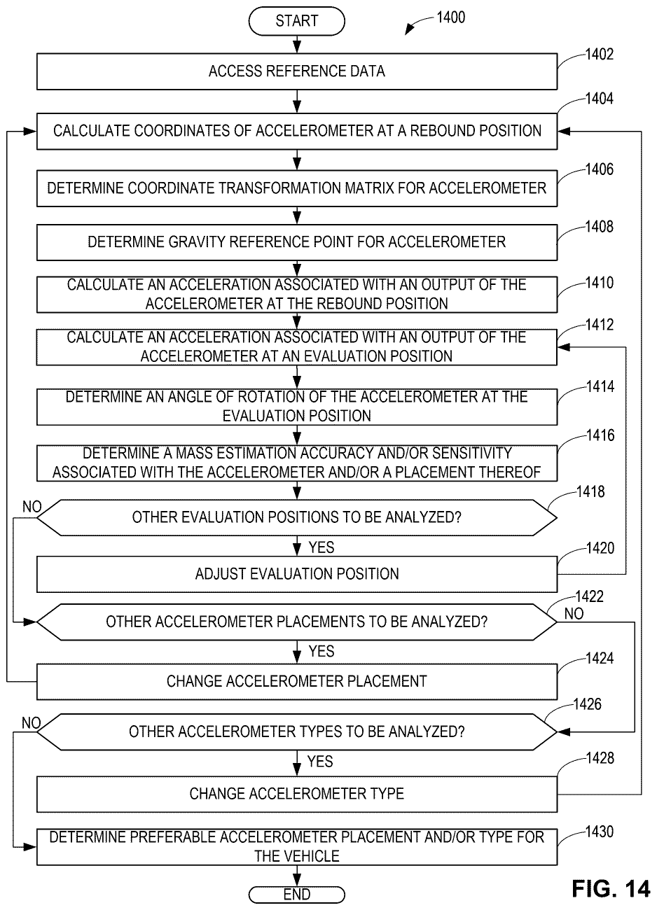

In some examples, the interface circuitry 1302 obtains, accesses, and/or receives sensor noise data. The sensor noise data can be characterized by noise source and an axis of the suspension accelerometer 102A, 102B, 102C, 102D that the noise affects. For example, the sensor noise data can include a first sensor noise parameter (e.g., in meters per second squared (m/s²)) associated with the sensor x-axis 1218A from a first noise source (e.g., the particular accelerometer 102A, 102B, 102C, 102D); a second sensor noise parameter associated with the sensor y-axis 1218B from the first noise source; a third noise parameter associated with the sensor z-axis from the first noise source; a fourth noise parameter associated with the sensor x-axis 1218A from a second noise source (e.g., environmental noise); a fifth noise parameter associated with the sensor y-axis 1218B from the second noise source; and a sixth noise parameter associated with the sensor z-axis from the second noise source. In some examples, interface circuitry 1302 is instantiated by programmable circuitry executing interface instructions and/or configured to perform operations such as those represented by the flowchart of FIG. 14.

In the illustrated example of FIG. 13, the sensor position analysis circuitry 1202 includes the loaded position calculation circuitry 1304 to calculate coordinates associated with the respective suspension accelerometers 102A, 102B, 102C, 102D at the rebound position. For example, the loaded position calculation circuitry 1304 can calculate an x-axis rebound reference point, a y-axis rebound reference point, a z-axis rebound reference point, and an origin rebound reference point associated with the location at which the respective suspension accelerometer 102A, 102B, 102C, 102D measures acceleration. In some examples, the loaded position calculation circuitry 1304 calculates the x-axis rebound reference point based on the x-axis rated reference point, the first rotation point, the second rotation point, and a rotation angle about first and second rotation points. For example, the loaded position calculation circuitry 1304 can utilize the Euler-Rodrigues rotational theory to calculate the x-axis rebound reference point. The loaded position calculation circuitry 1304 can similarly calculate the y-axis rebound reference point, the z-axis rebound reference point, and the origin rebound reference point. In some examples, the loaded position calculation circuitry 1304 is instantiated by programmable circuitry executing loaded position calculation instructions and/or configured to perform operations such as those represented by the flowchart of FIG. 14.

In the illustrated example of FIG. 13, the sensor position analysis circuitry 1202 includes the transformation matrix determination circuitry 1306 to determine a coordinate transformation matrix based on the x-axis rebound reference point, the y-axis rebound reference point, the z-axis rebound reference point, and the origin rebound reference point. For example, the coordinate transformation matrix can include a first unit vector from the origin rebound reference point to the x-axis rebound reference point, a second unit vector from the origin rebound reference point to the y-axis rebound reference point, and a third unit vector from the origin rebound reference point to the z-axis rebound reference point. In some examples, the transformation matrix determination circuitry 1306 can calculate new sensor axes associated with the rebound position as vectors that correspond to the first, second, and third unit vector. An example coordinate transformation matrix, T, is represented by Equation 10 below.

$$( Equation 10 )$$

$$T = \begin{matrix}Unit Vector from Origin ( Rebound ) to X - Axis Reference Point ( Rebound ) \\ Unit Vector from Origin ( Rebound ) to Y - Axis Reference Point ( Rebound ) \\ Unit Vector from Origin ( Rebound ) to Z - Axis Reference Point ( Rebound )\end{matrix}$$

Returning to the illustrated example of FIG. 13, the transformation matrix determination circuitry 1306 is instantiated by programmable circuitry executing transformation matrix determination instructions and/or configured to perform operations such as those represented by the flowchart of FIG. 14.

In the illustrated example of FIG. 13, the sensor position analysis circuitry 1202 includes the gravity reference point determination circuitry 1308 to determine a gravity reference point. For example, the gravity reference point can be directly below the origin rebound position in the global coordinate system 1220 of FIG. 12A. The gravity reference point, [X, Y, Z], is represented by Equation 11 below.

$$[ X , Y , Z ] = X - coordinate of origin rebound poisition , Y - coordinate of origin rebound poisition , ( Z - coordinate of origin rebound poisition - 9.80665 ) \qquad ( Equation 11 )$$

In some examples, the gravity reference point determination circuitry 1308 is instantiated by programmable circuitry executing gravity reference point determination instructions and/or configured to perform operations such as those represented by the flowchart of FIG. 14.

In the illustrated example of FIG. 13, the sensor position analysis circuitry 1202 includes the accelerometer output position calculation circuitry 1310 to calculate accelerations associated with an output of the respective accelerometer 102A, 102B, 102C, 102D at the rebound position. For example, the accelerometer output position calculation circuitry 1310 can utilize (e.g., execute) Equation 12 below to calculate accelerations, [Ax, Ay, Az], associated with the output of the respective accelerometer 102A, 102B, 102C, 102D at the rebound position.

$$[ Ax , Ay , Az ] = [ T ] * [ \text{} Gravity Reference Point ] - [ \text{} Origin Rebound Point ] - ( [ T ] * [ Origin Rebound Point ] - [ Origin Rebound Point ] ) \qquad ( Equation 12 )$$

Further, accelerometer output position calculation circuitry 1310 can utilize (e.g., execute) Equation 12 to determine accelerations associated with the output of the respective accelerometer 102A, 102B, 102C, 102D at different evaluation positions (e.g., positions obtained when the vehicle 1200 is carrying a load between the curb weight and the GAWR). Additionally or alternatively, the accelerometer output position calculation circuitry 1310 can determine the accelerations associated with an output of the respective accelerometer 102A, 102B, 102C, 102D at the rebound position and the evaluation position in another manner.

In some examples, the accelerometer output position calculation circuitry 1310 considers an influence of signal noise on the measurements by the respective accelerometer 102A, 102B, 102C, 102D at the rebound position and the evaluation position. For example, the noise result from a sensor communication bandwidth limit, a sensor internal electromagnetic compatibility (EMC) and/or root mean square (RMS) noise of the sensor (e.g., sensor produces noise+/−0.01 m/s² on all measurements), a sensor resolution limit (e.g., sensor can only measure down to 0.001 m/s²), a least significant bit limit of a sensor communication bus (e.g., sensor can only report in units of 0.02 m/s²), and/or environmental noise (e.g., electrostatic discharge (ESD) noise from nearby wires can cause+/−0.001 m/s² of noise in all measurements). In some examples, the accelerometer output position calculation circuitry 1310 is instantiated by programmable circuitry executing accelerometer output position calculation instructions and/or configured to perform operations such as those represented by the flowchart of FIG. 14.

In the illustrated example of FIG. 13, the sensor position analysis circuitry 1202 includes the suspension position calculation circuitry 1312 to determine a position and/or movement of the respective accelerometer 102A, 102B, 102C, 102D based on (i) the accelerations associated with the output of the respective accelerometer 102A, 102B, 102C, 102D at the rebound position and (ii) the accelerations associated with the output of the respective accelerometer 102A, 102B, 102C, 102D at the evaluation position. For example, the suspension position calculation circuitry 1312 can determine an angle of rotation of the respective accelerometer 102A, 102B, 102C, 102D about the axis defined between the first rotation point and the second rotation point based on (i) the accelerations associated with the output of the respective accelerometer 102A, 102B, 102C, 102D at the rebound position and (ii) the accelerations associated with the output of the respective accelerometer 102A, 102B, 102C, 102D at the evaluation position. For example, the suspension position calculation circuitry 1312 can utilize (e.g., execute) Equation 13 below to calculate the angle of rotation associated with the output from the respective accelerometer 102A, 102B, 102C, 102D.

$$Computed Angle = a tan 2 ( ( Accelerometer Output [ Ax , Ay , Az ] @ Evaluation Position + Potential Error and / or Limiting Factors in Sensor Reading ) , Accelerometer Output [ Ax , Ay , Az ] @ Rebound Position Position ) \qquad ( Equation 13 )$$

In some examples, the location of the accelerometer 102A, 102B, 102C, 102D provides more than one degree of freedom, such as when the accelerometer 102A, 102B is coupled to the lower strut joint 604 or the knuckle 606 of FIGS. 6 and 12C (e.g., the knuckle lower ball joint 1262 or the knuckle tie rod joint 1264 of FIG. 12C). In such examples, the suspension position calculation circuitry 1312 performs additional computations to convert an observed gravitational vector measured by the accelerometer 102A, 102B into a position of the lower strut joint 604 and/or the knuckle 606 of FIG. 6. For example, the suspension position calculation circuitry 1312 can utilize (e.g., execute) Equations 1-9 to determine the position of the lower strut joint 604 or the knuckle 606. The determined position of the lower strut joint 604 and/or the knuckle 606 can then be utilized to determine (e.g., mapped to) a force acting on the suspension system 400.

As discussed above, the potential error and/or limiting factors in the sensor reading can include a sensor communication bandwidth limit, a sensor internal electromagnetic compatibility (EMC) and/or root mean square (RMS) noise of the sensor (e.g., sensor produces noise+/−0.01 m/s² on all measurements), a sensor resolution limit (e.g., sensor can only measure down to 0.001 m/s²), a least significant bit limit of a sensor communication bus (e.g., sensor can only report in units of 0.02 m/s²), and/or environmental noise (e.g., electrostatic discharge (ESD) noise from nearby wires can cause+/−0.001 m/s² of noise in all measurements).

In some examples, the suspension position calculation circuitry 1312 is instantiated by programmable circuitry executing suspension position calculation instructions and/or configured to perform operations such as those represented by the flowchart of FIG. 14.

In the illustrated example of FIG. 13, the sensor position analysis circuitry 1202 includes the evaluation circuitry 1314 to determine a mass estimation accuracy and/or sensitivity associated with the respective accelerometer 102A, 102B, 102C, 102D and/or the location associated therewith (e.g., the locations 101, 301, 401, 501, 601, 701, 801, 901, 1001, 1101 of FIGS. 1 and 3-11). For example, the evaluation circuitry 1314 can compare the computed angle to a known angle associated with the evaluation point to determine a potential error associated with the respective accelerometer 102A, 102B, 102C, 102D and/or the location associated therewith.

Further, the evaluation circuitry 1314 can determine a measurement sensitivity (e.g., in kg/degree) associated with the respective accelerometer 102A, 102B, 102C, 102D and/or the location associated therewith based on Equation 14 below.

$$Measurement Sensitivity = \frac{GAWR Weight - Curb Weight}{Angle from Curb to GAWR} \qquad ( Equation 14 )$$

In some examples, the evaluation circuitry 1314 determines a mass estimation error (e.g., in kg) based on the determined measurement sensitivity and the determined potential error. For example, the evaluation circuitry 1314 can utilize (e.g., execute) Equation 15 below to determine the mass estimation error.

$$Mass Estimation Error = Measurement Sensitivity * Potential Error \qquad ( Equation 15 )$$

The evaluation circuitry 1314 can calculate respective mass estimation errors for different locations (e.g., the locations 101, 301, 401, 501, 601, 701, 801, 901, 1001, 1101 of FIGS. 1 and 3-11) of the accelerometers 102A, 102B, 102C, 102D. For example, the sensor position analysis circuitry 1202 can repeat the operations discussed above with the accelerometers 102A, 102B, 102C, 102D in different locations to determine which location provided a preferable (e.g., a lowest) mass estimation error across a suspension travel range from (i) the vehicle body 1210 supporting a curb weight to (ii) the vehicle body 1210 supporting a GAWR weight.

In some examples, the sensor position analysis circuitry 1202 repeats the operations discussed above with the accelerometers 102A, 102B, 102C, 102D implemented by different types of micro electromechanical systems that experience different levels of internal noise and/or have different maximum bus capacities. In such examples, the evaluation circuitry 1314 can determine which type of micro electromechanical system provided a preferable (e.g., a lowest) mass estimation error across a suspension travel range from (i) the vehicle body 1210 supporting a curb weight to (ii) the vehicle body 1210 supporting a GAWR weight. In some examples, the evaluation circuitry 1314 identifies the particular location and/or electromechanical system that is preferable based on the preferred evaluation metric from the interface circuitry 1302.

In some examples, the evaluation circuitry 1314 stores results including the mass estimation error, the potential error, and/or the measurement sensitivity associated with identifiers indicative of a location and/or micro electromechanical system associated with the respective accelerometer 102A, 102B, 102C, 102D via the database 1316. In some examples, the interface circuitry 1302 transmits the results to the user interface circuitry 1224. In some examples, the evaluation circuitry 1314 communicates the preferred location and/or electromechanical system for the accelerometers 102A, 102B, 102C, 102D to the assembly circuitry 1226, which installs the accelerometers 102A, 102B, 102C, 102D accordingly in ones of the vehicle 1200 to be utilized. In some examples, the evaluation circuitry 1314 is instantiated by programmable circuitry executing evaluation instructions and/or configured to perform operations such as those represented by the flowchart of FIG. 14.

In the illustrated example of FIG. 13, the sensor position analysis circuitry 1202 includes the load adjustment circuitry 1318 to increment the evaluation position from the curb weight (e.g., 10 degrees above the rebound position) to the GAWR (e.g., 15 degrees above the rebound position) in 0.10 steps. For example, the load adjustment circuitry 1318 can adjust the load supported by the vehicle 1200 and/or simulate such a load adjustment by changing the position of the suspension system 1206A, 1206B, 1206C, 1206D. In some examples, the load adjustment circuitry 1318 is instantiated by programmable circuitry executing evaluation instructions and/or configured to perform operations such as those represented by the flowchart of FIG. 14.

In the illustrated example of FIG. 13, the sensor position analysis circuitry 1202 includes the accelerometer adjustment circuitry 1320 to change the location and/or type of the accelerometer 102A, 102B, 102C, 102D implemented in the vehicle 1200. For example, after the different evaluation positions between the curb weight and the GAWR weight are tested for the accelerometer 102A in the location 401 of FIG. 4, the accelerometer adjustment circuitry 1320 can move the accelerometer 102A to the location 501 of FIG. 5. Further, after the different accelerometer locations available in the suspension system 1206A have been tested with a particular accelerometer type, the accelerometer adjustment circuitry 1320 can change a type of (e.g., the micro electromechanical system associated with) the accelerometer 102A and, in turn, obtain the mass estimation error of the newer type at the different evaluation positions and the different locations available in the suspension system 1206A. In some examples, the accelerometer adjustment circuitry 1320 is instantiated by programmable circuitry executing evaluation instructions and/or configured to perform operations such as those represented by the flowchart of FIG. 14.

While an example manner of implementing the sensor position analysis circuitry 1202 of FIG. 12A is illustrated in FIG. 13, one or more of the elements, processes, and/or devices illustrated in FIG. 13 may be combined, divided, re-arranged, omitted, eliminated, and/or implemented in any other way. Further, the example interface circuitry 1302, the example loaded position calculation circuitry 1304, the example coordinate transformation matrix determination circuitry 1306, the example gravity reference point determination circuitry 1308, the example accelerometer output position calculation circuitry 1310, the example suspension position calculation circuitry 1312, the example evaluation circuitry 1314, the example database 1316, the example load adjustment circuitry 1318, the example accelerometer adjustment circuitry 1320, and/or, more generally, the example sensor position analysis circuitry 1202 of FIG. 13, may be implemented by hardware alone or by hardware in combination with software and/or firmware. Thus, for example, any of the example interface circuitry 1302, the example loaded position calculation circuitry 1304, the example coordinate transformation matrix determination circuitry 1306, the example gravity reference point determination circuitry 1308, the example accelerometer output position calculation circuitry 1310, the example suspension position calculation circuitry 1312, the example evaluation circuitry 1314, the example database 1316, the example load adjustment circuitry 1318, the example accelerometer adjustment circuitry 1320, and/or, more generally, the example sensor position analysis circuitry 1202, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example sensor position analysis circuitry 1202 of FIG. 13 may include one or more elements, processes, and/or devices in addition to, or instead of, those illustrated in FIG. 13, and/or may include more than one of any or all of the illustrated elements, processes and devices.

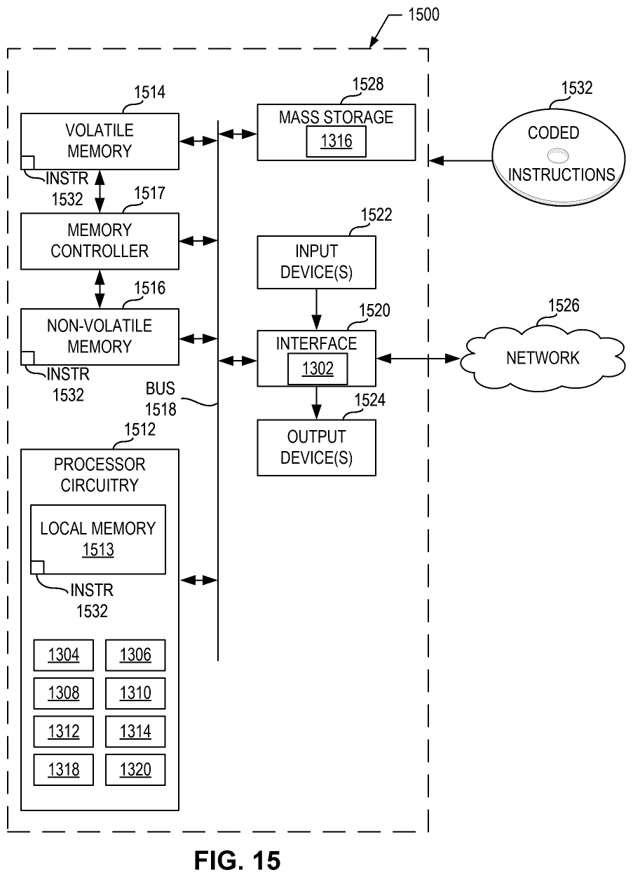

A flowchart representative of example machine readable instructions, which may be executed by programmable circuitry to implement and/or instantiate the sensor position analysis circuitry 1202 of FIG. 13 and/or representative of example operations which may be performed by programmable circuitry to implement and/or instantiate the sensor position analysis circuitry 1202 of FIG. 13, is shown in FIG. 14. The machine readable instructions may be one or more executable programs or portion(s) of one or more executable programs for execution by programmable circuitry such as the programmable circuitry 1512 shown in the example programmable circuitry platform 1500 discussed below in connection with FIG. 15 and/or may be one or more function(s) or portion(s) of functions to be performed by the example programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 14, many other methods of implementing the example sensor position analysis circuitry 1202 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 14 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 14 is a flowchart representative of example machine readable instructions and/or example operations 1400 that may be executed, instantiated, and/or performed by programmable circuitry to determine a preferable location for and/or type of an accelerometer to be coupled to a vehicle for a mass estimation to minimize or otherwise reduce a mass estimation error computed based on measurements from the accelerometer. The example machine-readable instructions and/or the example operations 1400 of FIG. 14 begin at block 1402, at which the sensor position analysis circuitry 1202 accesses reference data associated with a vehicle (e.g., the vehicle 1200 of FIG. 12A). For example, the interface circuitry 1302 can obtain the reference data associated with the vehicle 1200. The reference data can include example rated positions (e.g., design positions, initial positions) of the suspension accelerometers 102A, 102B, 102C, 102D. For example, the rated positions for the respective suspension accelerometers 102A, 102B, 102C, 102D can include an origin rated point, an x-axis rated reference point, a y-axis rated reference point, a z-axis rated reference point, a first rotation point, a second rotation point, an angle from a rebound position (e.g., a lowest point of travel for the respective suspension accelerometer 102A, 102B, 102C, 102D) to the rated position, and/or an angular travel of the suspension accelerometer 102A, 102B, 102C, 102D (e.g., from curb to GAWR) in degrees. In some examples, the interface circuitry 1302 accesses an identifier associated with a respective location of the accelerometer 102A, 102B, 102C, 102D (e.g., the locations 101, 301, 401, 501, 601, 701, 801, 901, 1001, 1101 of FIGS. 1 and 3-11), an identifier associated with a particular micro electromechanical system associated with the accelerometer 102A, 102B, 102C, 102D (e.g., a type of the accelerometer 102A, 102B, 102C, 102D), and/or a preferred evaluation metric.

At block 1404, the sensor position analysis circuitry 1202 calculates coordinates associated with the respective suspension accelerometer 102A, 102B, 102C, 102D at the rebound position. For example, the interface circuitry 1302 obtains data from the respective one(s) of the suspension accelerometers 102A, 102B, 102C, 102D. Further, the loaded position calculation circuitry 1304 can calculate an x-axis rebound reference point, a y-axis rebound reference point, a z-axis rebound reference point, and an origin rebound reference point associated with the location at which the respective suspension accelerometer 102A, 102B, 102C, 102D measures acceleration.

At block 1406, the sensor position analysis circuitry 1202 determines a coordinate transformation matrix for the accelerometer 102A, 102B, 102C, 102D. For example, the transformation matrix determination circuitry 1306 can determine the coordinate transformation matrix based on the x-axis rebound reference point, the y-axis rebound reference point, the z-axis rebound reference point, and the origin rebound reference point.

At block 1408, the sensor position analysis circuitry 1202 determines a gravity reference point for the accelerometer 102A, 102B, 102C, 102D. For example, the gravity reference point determination circuitry 1308 can determine the gravity reference point based on Equation 11 above.

At block 1410, the sensor position analysis circuitry 1202 calculates an acceleration associated with an output of the respective accelerometer 102A, 102B, 102C, 102D at the rebound position. For example, the accelerometer output position calculation circuitry 1310 can utilize (e.g., execute) Equation 12 above to calculate the accelerations, [Ax, Ay, Az], associated with the output of the respective accelerometer 102A, 102B, 102C, 102D at the rebound position.

At block 1412, the sensor position analysis circuitry 1202 calculates an acceleration associated with an output of the respective accelerometer 102A, 102B, 102C, 102D at an evaluation position. For example, the interface circuitry 1302 obtains data from the respective one(s) of the suspension accelerometers 102A, 102B, 102C, 102D. Further, the accelerometer output position calculation circuitry 1310 can utilize (e.g., execute) Equation 12 above to calculate the accelerations, [Ax, Ay, Az], associated with the output of the respective accelerometer 102A, 102B, 102C, 102D at the evaluation position.

At block 1414, the sensor position analysis circuitry 1202 determines a position and/or movement of the respective accelerometer 102A, 102B, 102C, 102D at the evaluation position. For example, the suspension position calculation circuitry 1312 can determine the angle of rotation of the respective accelerometer 102A, 102B, 102C, 102D about the axis defined between the first rotation point and the second rotation point based on (i) the accelerations associated with the output of the respective accelerometer 102A, 102B, 102C, 102D at the rebound position and (ii) the accelerations associated with the output of the respective accelerometer 102A, 102B, 102C, 102D at the evaluation position. For example, the suspension position calculation circuitry 1312 can utilize (e.g., execute) Equation 13 above to calculate the angle of rotation associated with the output from the respective accelerometer 102A, 102B, 102C, 102D. In some examples, the suspension position calculation circuitry 1312 utilizes (e.g., executes) Equations 1-9 to calculate the position and/or movement of the accelerometer 102A, 102B when the accelerometer 102A, 102B is coupled to the lower strut joint 604 (e.g., the location 601 of FIG. 6) and/or the knuckle 606 of FIGS. 6 and 12C.

At block 1416, the sensor position analysis circuitry 1202 determines a mass estimation accuracy and/or sensitivity associated with the respective accelerometer 102A, 102B, 102C, 102D and/or the location thereof (e.g., the location 101 of FIG. 1, the location 301 of FIG. 3, the location 401 of FIG. 4, the location 501 of FIG. 5, the location 601 of FIG. 6, the location 701 of FIG. 7, the location 801 of FIG. 8, the location 901 of FIG. 9, the location 1001 of FIG. 10, the location 1101 of FIG. 11). For example, the evaluation circuitry 1314 can determine the mass estimation accuracy and/or sensitivity. In some examples, the evaluation circuitry 1314 stores the mass estimation accuracy and/or sensitivity with respective identifiers associated with the evaluation position, the accelerometer location, and/or the accelerometer type via the database 1316.

At block 1418, the sensor position analysis circuitry 1202 determines whether other evaluation positions are to be analyzed for the respective accelerometer 102A, 102B, 102C, 102D. For example, the evaluation circuitry 1314 can determine whether other evaluation positions are to be analyzed for the implemented location and/or type of accelerometer 102A, 102B, 102C, 102D. When other evaluation positions are to be analyzed, the operations 1400 proceed to block 1420. Otherwise, the operations 1400 skip to block 1422.

At block 1420, the sensor position analysis circuitry 1202 adjusts the evaluation position. For example, the load adjustment circuitry 1318 can adjust the load supported by the vehicle 1200 to adjust the evaluation position. In some examples, the load adjustment circuitry 1318 causes adjustments in 0.1° increments between a degree position associated with a curb weight of the vehicle 1200 and a degree position associated with a GAWR of the vehicle 1200. After block 1420, the operations 1400 return to block 1412.

At block 1422, the sensor position analysis circuitry 1202 determines whether other accelerometer locations are to be analyzed. For example, the evaluation circuitry 1314 can determine whether there are other locations for the accelerometers 102A, 102B, 102C, 102D that can be utilized in the vehicle 1200 and that have not yet been assessed for mass estimation error and/or sensitivity. When other accelerometer locations are to be analyzed, the operations proceed to block 1424. Otherwise, the operations 1400 skip to block 1426.

At block 1424, the sensor position analysis circuitry 1202 changes the accelerometer location. For example, the accelerometer adjustment circuitry 1320 can move the respective accelerometer 102A, 102B, 102C, 102D to a new location on the suspension system 1206A, 1206B, 1206C, 1206D that has not yet been assessed for mass estimation error and/or sensitivity. In some examples, the accelerometer adjustment circuitry 1320 causes a portion of the suspension system 1206A, 1206B, 1206C, 1206D to be replaced. After block 1424, the operations 1400 return to block 1404.

At block 1426, the sensor position analysis circuitry 1202 determines whether other accelerometer types are to be analyzed. For example, the evaluation circuitry 1314 can determine whether there are other types of micro electromechanical systems that can be utilized to implement the accelerometers 102A, 102B, 102C, 102D and that have not yet been assessed for mass estimation error and/or sensitivity. When other accelerometer types are to be analyzed, the operations 1400 proceed to block 1428. Otherwise, the operations 1400 proceed to block 1430.

At block 1428, the sensor position analysis circuitry 1202 changes the accelerometer type. For example, the accelerometer adjustment circuitry 1320 can change the micro electromechanical system associated with measurements performed by the respective accelerometer 102A, 102B, 102C, 102D to one that has not yet been assessed for mass estimation error and/or sensitivity. After block 1428, the operations 1400 return to block 1404.

At block 1430, the sensor position analysis circuitry 1202 determines a preferable location and/or type for the accelerometer 102A, 102B, 102C, 102D to be implemented in the vehicle 1200. For example, the evaluation circuitry 1314 can determine which accelerometer location and/or type provided a preferable (e.g., a lowest) mass estimation error across a suspension travel range from (i) the vehicle body 1210 supporting a curb weight to (ii) the vehicle body 1210 supporting a GAWR weight. In some examples, the evaluation circuitry 1314 causes the interface circuitry 1302 to transmit information indicative of the preferable location and/or type for the accelerometer 102A, 102B, 102C, 102D to the user interface circuitry 1224 and/or the assembly circuitry 1226.

FIG. 15 is a block diagram of an example programmable circuitry platform 1500 structured to execute and/or instantiate the example machine-readable instructions and/or the example operations of FIG. 14 to implement the sensor position analysis circuitry 1202 of FIG. 13. The programmable circuitry platform 1500 can be, for example, a server, a personal computer, a workstation, a self-learning machine (e.g., a neural network), a mobile device (e.g., a cell phone, a smart phone, a tablet such as an iPad™), or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer. The programmable circuitry 1512 may be implemented by one or more semiconductor based (e.g., silicon based) devices. In this example, the programmable circuitry 1512 implements the example loaded position calculation circuitry 1304, the example coordinate transformation matrix determination circuitry 1306, the example gravity reference point determination circuitry 1308, the example accelerometer output position calculation circuitry 1310, the example suspension position calculation circuitry 1312, the example evaluation circuitry 1314, the example load adjustment circuitry 1318, and the example accelerometer adjustment circuitry 1320 of FIG. 13.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. In some examples, the memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an accelerometer (e.g., the accelerometer 102 of FIGS. 1-11B, the accelerometers 102A, 102B, 102C, 102D of FIG. 12A, etc.), an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by a manufacturing machine (e.g., the assembly circuitry 1226 of FIG. 12A), an actuator, and/or user interface circuitry (e.g., the user interface circuitry 1224 of FIG. 12A), such as display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1520 implements the interface circuitry 1302 of FIG. 13. Accordingly, the interface circuitry 1520 can be communicatively coupled to the suspension accelerometers 102A-D, the body accelerometer 1208, the user interface circuitry 1224, and the assembly circuitry 1226.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the mass storage discs or devices 1528 implement the database 1316 of FIG. 13.

The machine readable instructions 1532, which may be implemented by the machine readable instructions of FIG. 14, may be stored in the mass storage device 1528, in the volatile memory 1514, in the non-volatile memory 1516, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide accelerometer locations that can be implemented in a vehicle and utilized for a vehicle mass estimation. Additionally, examples disclosed herein determine a preferable location for and/or type of the accelerometer to be implemented in the vehicle for the mass estimation that minimizes or otherwise reduces a mass estimation error that is computed based on measurements from the accelerometer.

Accelerometer locations in a vehicle for weight estimation and associated methods are disclosed herein. Further examples and combinations thereof include the following:

Example 1 includes a vehicle comprising a suspension system including an upper control arm, a lower strut joint, or a leaf spring and a shackle to operatively couple a wheel to a frame of the vehicle, and an accelerometer coupled to the upper control arm, the lower strut joint, or the shackle, a position of the accelerometer to change when the upper control arm, the lower strut joint, or the shackle moves from a change in a load being supported by the vehicle.

Example 2 includes the vehicle of example 1, wherein the accelerometer is coupled to the upper control arm.

Example 3 includes the vehicle of any preceding example, wherein the accelerometer is coupled to the shackle and positioned above or below an end of the leaf spring.

Example 4 includes the vehicle of any preceding example, wherein the accelerometer is coupled to the shackle, and wherein at least a portion of the accelerometer is positioned rearward of an end of the leaf spring.

Example 5 includes the vehicle of any preceding example, wherein the accelerometer includes a first end and a second end opposite the first end, wherein the first end is coupled to the upper control arm or the shackle, and wherein the accelerometer is angled to position at least a portion of the second end above the first end to prevent liquid from infiltrating the accelerometer.

Example 6 includes the vehicle of any preceding example, further including a plate coupled to the shackle, wherein the accelerometer is coupled to the plate.

Example 7 includes the vehicle of any preceding example, wherein at least a portion of the accelerometer is positioned closer than the shackle to a rear of the vehicle.

Example 8 includes the vehicle of any preceding example, further including a washer coupled to the shackle via a fastener that couples the leaf spring to the shackle, wherein the accelerometer is coupled to the washer.

Example 9 includes the vehicle of any preceding example, wherein the leaf spring is positioned across a first portion of a longitudinal span of the vehicle, wherein at least a portion of the accelerometer is positioned outside of the first portion of the longitudinal span of the vehicle.

Example 10 includes the vehicle of any preceding example, wherein the washer includes a projection to limit a rotation of the washer when coupling the fastener to the shackle.

Example 11 includes the vehicle of any preceding example, wherein the orientation of the accelerometer pivots by no more than approximately one degree per 50 kilograms added to the vehicle between a curb weight and a gross axle weight rating of the vehicle.

Example 12 includes a vehicle comprising a suspension system including an upper control arm, a lower strut joint, or a leaf spring and a shackle to couple an end of the leaf spring to a frame of the vehicle, the leaf spring including leaves and a clinch clip to couple the leaves, and an accelerometer to couple to the upper control arm, the shackle, or the clinch clip.

Example 13 includes the vehicle of any preceding example, wherein the accelerometer is coupled to the clinch clip, the leaf spring is coupled to a rear axle of the vehicle, and wherein the accelerometer is positioned closer than the rear axle to a front of the vehicle.

Example 14 includes the vehicle of any preceding example, wherein the shackle includes a first end to couple to a body of the vehicle and a second end to couple to the leaf spring, the accelerometer is coupled to the shackle, and at least a portion of the accelerometer is positioned between the first end and the second end in a vertical direction defined by the vehicle.

Example 15 includes the vehicle of any preceding example, wherein an axis about which the accelerometer pivots is co-axial with a fastener that couples the leaf spring to the shackle.

Example 16 includes the vehicle of any preceding example, wherein the leaf spring includes a first end and a second end opposite the first end, the first end coupled to the shackle, the accelerometer coupled to the shackle, and at least a portion of the accelerometer positioned between the first end and the second end in a longitudinal direction defined by the vehicle.

Example 17 includes the vehicle of any preceding example, wherein at least a portion of the accelerometer moves upwards when a load supported by the vehicle increases.

Example 18 includes a vehicle comprising a suspension system including at least one of an upper control arm, a lower control arm, a leaf spring, or a shackle to couple an end of the leaf spring to a frame of the vehicle, and an accelerometer including a first end and a second end opposite the first end, the first end coupled to the upper control arm, the lower control arm, the shackle, or the leaf spring, the accelerometer disposed at an angle that positions at least a portion of the second end above the first end.

Example 19 includes the vehicle of any preceding example, wherein the accelerometer includes a cap positioned at the second end to cover internal electronic components, and wherein the angle drains liquid away from the cap.

Example 20 includes the vehicle of any preceding example, wherein the accelerometer is coupled to a surface of the lower control arm that faces a longitudinal direction defined by the vehicle.

Example 21 includes the vehicle of any preceding example, wherein the accelerometer is coupled to the lower strut joint, and wherein the accelerometer moves with more than one degree of freedom when the load supported by the vehicle changes.

Example 22 includes the vehicle of any preceding example, further including programmable circuitry to determine the position of the accelerometer based on an upper strut location, a lower spring location, a control arm center of rotation, a control arm rear fastener point, an inner tie rod end, a control arm length, a first knuckle length, a second knuckle length, a third knuckle length, and a tie rod length.

Example 23 includes the vehicle of any preceding example, wherein an orientation of the accelerometer pivots by no more than approximately one degree per 50 kilograms added to the vehicle between a curb weight and a gross axle weight rating of the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a suspension system including an upper control arm, a lower strut joint, or a leaf spring and a shackle to operatively couple a wheel to a frame of the vehicle; and
an accelerometer coupled to the upper control arm, the lower strut joint, or the shackle, a position of the accelerometer to change when the upper control arm, the lower strut joint, or the shackle moves from a change in a load being supported by the vehicle.

2. The vehicle of claim 1, wherein the accelerometer is coupled to the upper control arm.

3. The vehicle of claim 1, wherein the accelerometer is coupled to the shackle and positioned above or below an end of the leaf spring.

4. The vehicle of claim 1, wherein the accelerometer is coupled to the shackle, and wherein at least a portion of the accelerometer is positioned rearward of an end of the leaf spring.

5. The vehicle of claim 1, wherein the accelerometer includes a first end and a second end opposite the first end, wherein the first end is coupled to the upper control arm or the shackle, and wherein the accelerometer is angled to position at least a portion of the second end above the first end to prevent liquid from infiltrating the accelerometer.

6. The vehicle of claim 1, further including a plate coupled to the shackle, wherein the accelerometer is coupled to the plate.

7. The vehicle of claim 1, further including a washer coupled to the shackle via a fastener that couples the leaf spring to the shackle, wherein the accelerometer is coupled to the washer.

8. The vehicle of claim 7, wherein the leaf spring is positioned across a first portion of a longitudinal span of the vehicle, wherein at least a portion of the accelerometer is positioned outside of the first portion of the longitudinal span of the vehicle.

9. The vehicle of claim 7, wherein the washer includes a projection to limit a rotation of the washer when coupling the fastener to the shackle.

10. The vehicle of claim 1, wherein the accelerometer is coupled to the lower strut joint, and wherein the accelerometer moves with more than one degree of freedom when the load supported by the vehicle changes.

11. The vehicle of claim 10, further including programmable circuitry to determine the position of the accelerometer based on an upper strut location, a lower spring location, a control arm center of rotation, a control arm rear fastener point, an inner tie rod end, a control arm length, a first knuckle length, a second knuckle length, a third knuckle length, and a tie rod length.

12. A vehicle comprising:
a suspension system including an upper control arm, a lower strut joint, or a leaf spring and a shackle to couple an end of the leaf spring to a frame of the vehicle, the leaf spring including leaves and a clinch clip to couple the leaves; and
an accelerometer to couple to the upper control arm, the lower strut joint, the shackle, or the clinch clip.

13. The vehicle of claim 12, wherein the accelerometer is coupled to the clinch clip, the leaf spring is coupled to a rear axle of the vehicle, and wherein the accelerometer is positioned closer than the rear axle to a front of the vehicle.

14. The vehicle of claim 12, wherein the shackle includes a first end to couple to a body of the vehicle and a second end to couple to the leaf spring, the accelerometer is coupled to the shackle, and at least a portion of the accelerometer is positioned between the first end and the second end in a vertical direction defined by the vehicle.

15. The vehicle of claim 12, wherein an axis about which the accelerometer pivots is co-axial with a fastener that couples the leaf spring to the shackle.

16. The vehicle of claim 12, wherein the leaf spring includes a first end and a second end opposite the first end, the first end coupled to the shackle, the accelerometer coupled to the shackle, and at least a portion of the accelerometer positioned between the first end and the second end in a longitudinal direction defined by the vehicle.

17. The vehicle of claim 12, wherein at least a portion of the accelerometer moves upwards when a load supported by the vehicle increases.

18. A vehicle comprising:
a suspension system including at least one of an upper control arm, a lower control arm, a leaf spring, or a shackle to couple an end of the leaf spring to a frame of the vehicle; and
an accelerometer including a first end and a second end opposite the first end, the first end coupled to the upper control arm, the lower control arm, the lower strut joint, the shackle, or the leaf spring, the accelerometer disposed at an angle that positions at least a portion of the second end above the first end.

19. The vehicle of claim 18, wherein the accelerometer includes a cap positioned at the second end to cover internal electronic components, and wherein the angle drains liquid away from the cap.

20. The vehicle of claim 18, wherein an orientation of the accelerometer pivots by no more than approximately one degree per 50 kilograms added to the vehicle between a curb weight and a gross axle weight rating of the vehicle.
